(19) United States
(12) Patent Application Publication
(10) Pub. No.: US 2025/0373332 A1
(43) Pub. Date: Dec. 4, 2025

(54) SYSTEM AND METHOD FOR REAL-TIME NETWORK OPTIMIZATION USING NATURAL INTELLIGENCE IN OPTICAL COMMUNICATIONS

(71) Applicant: AI Atlas Inc., Hamilton (CA)

(72) Inventors: Mahdi Naghshvarianjahromi, Hamilton (CA); Shiva Kumar, Hamilton (CA); M. Jamal Deen, Hamilton (CA)

(21) Appl. No.: 18/884,189

(22) Filed: Sep. 13, 2024

Related U.S. Application Data
(60) Provisional application No. 63/654,800, filed on May 31, 2024.

(51) Int. Cl. H04B 10/079

(52) U.S. Cl. CPC H04B 10/07953

(57) ABSTRACT

What is disclosed is: a method for natural intelligence (NI) processing for a software-defined optical communication system (SDOCS). The method comprises receiving perceptions comprising a plurality of transmitted symbols, and determining, based on the received plurality of transmitted symbols, whether a suitable posterior model is available. When a suitable posterior model is available, the model is retrieved. The retrieved posterior model is used to estimate a BER, and the estimated BER is communicated to an executive subsystem. When the estimated BER is below a threshold, a prospective action is selected. The selected prospective action is tested in a virtual environment to determine whether the prospective action is beneficial. When the selected prospective action is beneficial, it is communicated to a feedback subsystem. Signals comprising the selected prospective action are received. An adjustment to implement the selected prospective action is determined, and signals to perform the determined adjustment are transmitted.

### FIELD OF THE INVENTION

The present disclosure relates to the field of optical networks, specifically to the application of natural intelligence (NI) to optical networks and, more specifically, to optical networks with non-Gaussian and non-linear environments (NGNLE).

### BRIEF SUMMARY

A system for natural intelligence (NI) processing in a reception subsystem for a software defined optical communications system (SDOCS) comprising: a perceptor subsystem communicatively coupled to an executive subsystem via interconnections, wherein: the perceptor subsystem comprises a posterior storage and one or more posterior processing modules coupled to each other by perceptor subsystem interconnections, and the executive subsystem comprises an executive storage, one or more executive processing modules and a planning module coupled to each other by executive subsystem interconnections; a feedback subsystem communicatively coupled to the executive subsystem, a transmission subsystem, a reception subsystem and an input client data source, wherein: the feedback subsystem comprises a feedback processing module communicatively coupled to a feedback subsystem database, further wherein: the feedback processing module comprises a feedback subsystem firmware running on a feedback subsystem processor; an adaptive feedback path control module communicatively coupled to the executive subsystem and the perceptor subsystem, wherein: the perceptor subsystem receives perceptions comprising a plurality of transmitted symbols, based on the received plurality of transmitted symbols, determining whether a suitable posterior model is available in the posterior storage, when a suitable posterior model is available, the one or more posterior processing modules retrieves a posterior model from the posterior storage, and the one or more posterior processing modules communicates the retrieved posterior model to the adaptive feedback path control module, the adaptive feedback path control module estimates a BER using the retrieved posterior model, the adaptive feedback path control module communicates the estimated BER to the executive subsystem, when the estimated BER is below a threshold, the planning module selects a prospective action from the executive storage, at least one of the planning module and the one or more executive processing modules test the selected prospective action in a virtual environment, at least one of the planning module and the one or more executive processing modules determines whether the selected prospective action is beneficial, when the selected prospective action is beneficial, either the planning module or the one or more executive processing modules communicates signals comprising the selected prospective action to the feedback subsystem, and the feedback processing module: receives the signals comprising the selected prospective action, determines, based on the received signals, an adjustment to implement the selected prospective action, and transmits signals to perform the determined adjustment to one or more components within the transmission or the reception, or the input client data source.

A method for NI processing in a reception subsystem for an SDOCS comprising: receiving, by a perceptor subsystem, perceptions comprising a plurality of transmitted symbols; determining, based on the received plurality of transmitted symbols, whether a suitable posterior model is available in a posterior storage within the posterior subsystem; when a suitable posterior model is available, retrieving, by one or more posterior processing modules within the posterior subsystem, a posterior model from the posterior storage; communicating, by the one or more posterior processing modules, the retrieved posterior model to an adaptive feedback path control; estimating, by the adaptive feedback path control module, a BER using the retrieved posterior model; communicating the estimated BER to an executive subsystem; when the estimated BER is below a threshold, selecting, by a planning module within the executive subsystem, a prospective action from an executive storage; testing, by at least one of the planning module and one or more executive processing modules within the executive subsystem, the selected prospective action in a virtual environment; based on the testing, determining, by at least one of the planning module and one or more executive processing modules, whether the selected prospective action is beneficial; when the selected prospective action is beneficial, communicating, by either the planning module or the one or more executive processing modules, signals comprising the selected prospective action to a feedback subsystem; receiving, by a feedback processing module within the feedback subsystem, the signals comprising the selected prospective action; based on the received signals, determining, by the feedback processing module, an adjustment to implement the selected prospective action; and transmitting, by the feedback processing module, signals to perform the determined adjustment to one or more components within a transmission in the SDOCS, a reception within the SDOCS, or an input client data source to the SDOCS.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1A illustrates an example embodiment of a software-defined optical communication system (SDOCS) that integrates natural intelligence (NI).

FIG. 1B shows an example embodiment of a transmission subsystem.

FIG. 1C shows an example embodiment of a reception system.

FIG. 1D shows an example embodiment of a feedback subsystem.

FIG. 1E shows an example embodiment of a transmission sequence in an SDOCS.

FIG. 1F shows an example embodiment of a reception sequence in SDOCS.

FIG. 2A illustrates an example embodiment of a NI processing subsystem.

FIG. 2B illustrates an example embodiment of a perceptor subsystem.

FIG. 2C illustrates an example embodiment of an executive subsystem.

FIG. 3 illustrates an example embodiment of a perceptor posterior processing flow.

FIG. 4A illustrates an example embodiment of a posterior extraction processing flow.

FIG. 4B illustrates a signal space for an example embodiment of a posterior extraction processing flow.

FIG. 4C illustrates an example embodiment of a process to set parameters for discretization.

FIG. 4D illustrates an example embodiment of a process for a non-Bayesian approach to estimate transmitted symbols based on discretized symbols.

FIG. 5A illustrates part of an example embodiment of an executive subsystem process flow.

FIG. 5B illustrates another part of an example embodiment of an executive subsystem process flow.

FIG. 6 illustrates an example embodiment of parameters available to an executive subsystem to adjust using actions.

FIG. 7A illustrates a graph of bit error rate (BER) versus launch power for an embodiment of an Optical Time Division Multiplexing (OTDM) setup with imperfect clock recovery.

FIG. 7B illustrates a graph of BER versus launch power for an embodiment of an OTDM setup with near-perfect clock recovery.

FIG. 8A illustrates BER variation for a group of frames in an OTDM setup with imperfect clock recovery.

FIG. 8B illustrates BER variation for a group of frames in an OTDM setup with near-perfect clock recovery.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### BACKGROUND

As the demand for higher data rates, lower latency, lower power consumption, and lower digital signal processing complexity escalates with the advent of 5G/6G networks, the limitations of current technologies, including wavelength division multiplexing (WDM), erbium-doped fiber amplifiers (EDFA), and coherent receivers, become more apparent. One of the paramount challenges is overcoming nonlinear impairments that obstruct data transmission efficiency.

Traditionally, methods like digital backpropagation (DBP) and various perturbation techniques have been employed to mitigate these nonlinear effects by solving the nonlinear Schrödinger equation (NLSE) in the digital domain. However, these approaches often suffer from high computational demands, higher power consumption, higher latency, and require an in-depth understanding of the specific parameters of fiber-optic links, and are not inherently adaptive. This makes them impractical for real-time applications, leading to increased latency and reduced system efficiency, as discussed in, for example, S. Kumar and M. J. Deen, Fiber optic communications: fundamentals and applications (John Wiley & Sons, 2014).

Recently, artificial intelligence (AI) and machine learning algorithms have been proposed as advanced solutions to these persistent challenges. However, these AI-based approaches are hampered by high computational complexity and sometimes the necessity for detailed knowledge of fiber-optic link parameters, thereby limiting their practical utility and adaptability in dynamically changing environments. See, for example, S. Zhang, F. Yaman, K. Nakamura, et al. “Field and lab experimental demonstration of nonlinear impairment compensation using neural networks,” Nature Communications, vol. 10, 3033, 2019.

Natural intelligence (NI) presents a revolutionary approach by drawing inspiration from the adaptive behavior and cognitive functions observed in the human brain. NI encompasses a system designed to perceive the environment, cognitively act upon it, and utilize feedback mechanisms to adapt actions based on the outcomes. This is encapsulated in the perception-action cycle (PAC), a concept that enables dynamic adjustment to the environment through goal-directed behaviors, closely mirroring human cognitive processes in responding to environmental stimuli. Further information on the PAC is given in, for example, J. M., Fuster, Cortex and mind: Unifying cognition. (Oxford University, 2003).

Cognitive Dynamic Systems (CDS), which are synonymous with NI has demonstrated broad applicability across a myriad of fields, including cognitive radar, smart grid management, and cybersecurity. This diversity underscores the system's adaptability and efficacy within linear and Gaussian environments (LGEs). Notably, as outlined in S. Haykin, Cognitive Dynamic Systems: Perception-Action Cycle, Radar, and Radio, (Cambridge University, 2012), the foundation of these applications is built on algorithms that predominantly cater to linear and Gaussian models. Central to these traditional CDS frameworks is the use of Kalman filtering, among other methods, which, while robust for LGEs, incurs significant computational overhead. This renders such approaches less practical for deployment in non-Gaussian and nonlinear environments (NGNLEs), which are characteristic of the emerging fields of software-defined optical communication systems (SDOCS), healthcare technologies, and educational systems.

The inherent computational intensity of Kalman filtering and the reliance on simplified equations for LGEs present a notable challenge in optical communications. In optical communications, the luxury of high computational resources is often unattainable. Given the rapid transmission rates and the need for real-time processing within SDOCS, there is minimal room for algorithms that do not efficiently scale or that demand extensive computational power. The linear assumptions and Gaussian noise models typical of Kalman filtering and similar algorithms fail to accurately represent or address the complex dynamics and uncertainty present in NGNLEs, such as the fiber optic links used in high-speed optical communications.

This discrepancy or critical gap underscores the necessity for a paradigm shift towards developing and implementing NI algorithms specifically designed for NGNLEs. Such algorithms must transcend the limitations of traditional linear and Gaussian assumptions, offering scalable, computationally efficient solutions capable of tackling the inherent complexities of NGNLEs.

The application of NI to SDOCS has been contemplated before. For example, in Naghshvarianjahromi, M.; Kumar, S.; Deen, M. J. Brain Inspired Dynamic System for the Quality of Service Control over the Long-Haul Nonlinear Fiber-Optic Link. Sensors 2019, 19, 2175; hereinafter referred to as “Naghshvarianjahromi 1”, a system for application of NI to SDOCS is demonstrated. However, in Naghshvarianjahromi 1, the decision-making block was placed before the feedback channel. This placement limits real-time improvement and makes it challenging for the system in Naghshvarianjahromi 1 to provide accurate internal rewards, due to sole reliance on NI without an efficient feedback mechanism. In the system of Naghshvarianjahromi 1, the feedback channel design is based on measured BER. This reliance on measured BER without a sophisticated feedback mechanism makes it difficult for the system to adapt effectively. The perceptor subsystem used in Naghshvarianjahromi 1 uses traditional signal processing techniques, and actions for virtual actions or update of design are limited to adjustment of data rates. Also, Naghshvarianjahromi 1 does not use pre-adaptive actions, which are predetermined actions designed to be effective before the system has had a chance to learn or adapt from experience. Naghshvarianjahromi 1 exhibits less complexity in managing steady states, and focuses on immediate adjustments without detailed steady state management. The feedback mechanisms in Naghshvarianjahromi 1 focus on immediate states without in-depth monitoring. Furthermore, the perceptor subsystem in Naghshvarianjahromi 1 first extracts the Bayesian model and then the posterior from a database, which significantly increases computational cost, as will be explained below, and impacts performance when the steady state is off. Finally, Naghshvarianjahromi 1 does not contemplate the complexities of generating training data in real-time systems.

Naghshvarianjahromi, M.; Kumar, S.; Deen, M. J. Brain-Inspired Cognitive Decision Making for Nonlinear and Non-Gaussian Environments. IEEE Access 2019, 7, 180910-180922; hereinafter referred to as “Naghshvarianjahromi 2”, demonstrates another system for application of NI to SDOCS. Naghshvarianjahromi 2 suffers from many of the same failings as Naghshvarianjahromi 1. A difference is that Naghshvarianjahromi 2 uses more sophisticated feedback but not with the same integration. Additionally, while Naghshvarianjahromi 2 uses more advanced cognitive processing, it does not utilize the same posterior library and layered extraction method.

Naghshvarianjahromi, M.; Kumar, S.; Deen, M. J. Natural Brain-Inspired Intelligence for Non-Gaussian and Nonlinear Environments with Finite Memory. Appl. Sci. 2020, 10, 1150; hereinafter referred to as “Naghshvarianjahromi 3”, also suffers from many of the same failings as Naghshvarianjahromi 1 and Naghshvarianjahromi 2. In Naghshvarianjahromi 3, the feedback channel design is based on the assurance factor. This makes it difficult for the system in Naghshvarianjahromi 3 to provide good internal rewards solely relying on NI. Also, Naghshvarianjahromi 3 uses more limited neural network-based adjustments, specifically without detailed internal command structures.

Naghshvarianjahromi, M.; Kumar, S.; Deen, M. J.; Iwaya, T.; Kimura, K.; Yoshida, M.; Hirooka, T.; Nakazawa, M. Software-Defined Fiber Optic Communications for Ultrahigh-Speed Optical Pulse Transmission Systems. IEEE J. Sel. Top. Quantum Electron. 2022, 28, 1-10, hereinafter referred to as Naghshvarianjahromi 4, suffers from a failing of requiring databases to train.

Other examples of works of prior art which have covered similar or related subject matter are:
United States (US) U.S. Pat. No. 9,735,881 to Agazzi et al., with an issue date of Aug. 15, 2017;
U.S. Pat. No. 10,742,327 to Agazzi et al., with an issue date of Aug. 11, 2020;
U.S. Pat. No. 9,838,131 to Voois et al., with an issue date of Dec. 5, 2017;
U.S. Pat. No. 10,069,571 to Voois et al., with an issue date of Sep. 4, 2018;
U.S. Pat. No. 10,880,010 to Voois et al., with an issue date of Dec. 29, 2020;
U.S. Pat. No. 11,483,074 to Voois et al., with an issue date of Oct. 25, 2022;
U.S. Pat. No. 10,038,506 to Crivelli et al., with an issue date of Jul. 31, 2018;
U.S. Pat. No. 10,110,317 to Morero et al., with an issue date of Oct. 23, 2018;
U.S. Pat. No. 10,432,313 to Fan et al., with an issue date of Oct. 1, 2019;
U.S. Pat. No. 11,494,186 to Langhammer et al., with an issue date of Nov. 8, 2022; and
U.S. Pat. No. 11,923,896 to Smith et al., with an issue date of Mar. 5, 2024.
   However, none of these works of prior art mention or even contemplate the use of NI algorithms for NGNLEs.

### DETAILED DESCRIPTION

One of ordinary skill in the art would appreciate that while the systems and methods detailed below target optical fiber communications, they could be applied to other types of communication systems, for example, wireless communications systems.

The systems and methods detailed below address the shortcomings mentioned above by modifying, refining, and enhancing existing natural intelligence (NI) frameworks for application in NGNLEs within the realm of optical communication systems. The systems and methods detailed below address the challenges posed by nonlinear impairments more efficiently than traditional and AI-based methods in optical communication systems. The systems and methods detailed below deliver many advantages and pave the way for more robust, efficient, and intelligent optical communication systems.

The systems and methods employ NI to address and surmount the inherent limitations traditionally encountered in software-defined optical communication systems (SDOCS), non-Gaussian randomness, notably nonlinear impairments, and the challenges in real-time monitoring and dynamic management of the communication channel. As will be seen, the systems and methods detailed below provide lower computational complexity and higher capability to operate effectively without requiring detailed prior knowledge of the channel parameters when compared to prior art systems.

Using perception and action, and feedback mechanisms, the systems and methods detailed below significantly improve the bit error rate (BER) and also enhance overall system reliability by intelligently monitoring and managing the communication link, akin to serving as the central cognitive engine or the ‘brain’ within SDOCS.

The systems and methods described below provide a framework for the smart management and proactive monitoring of the optical link, enabling the system to anticipate, adapt to, and effectively counteract potential issues before they impact performance. This advanced capability ensures a more resilient, efficient, and intelligent network management approach and outperforms traditional and AI-based methods in handling nonlinearities. Integrating the NI into SDOCS enables a future where optical networks are both reactive and dynamically adaptive.

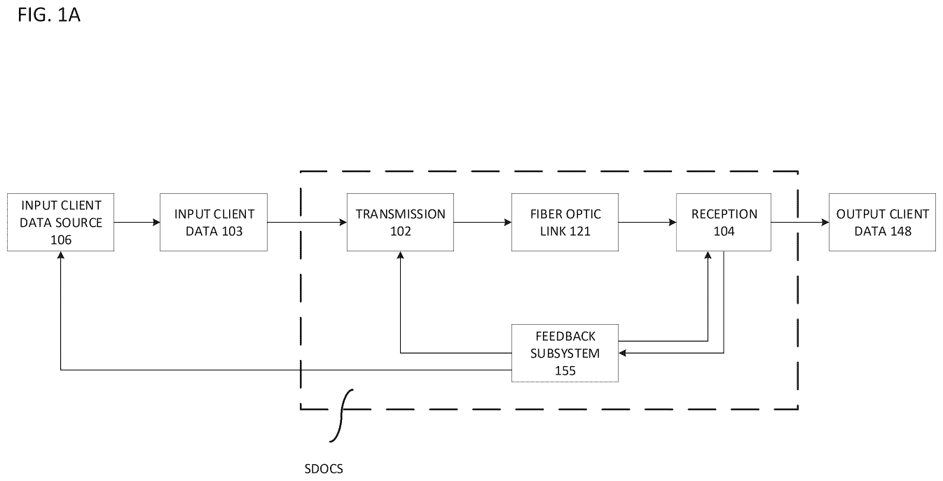

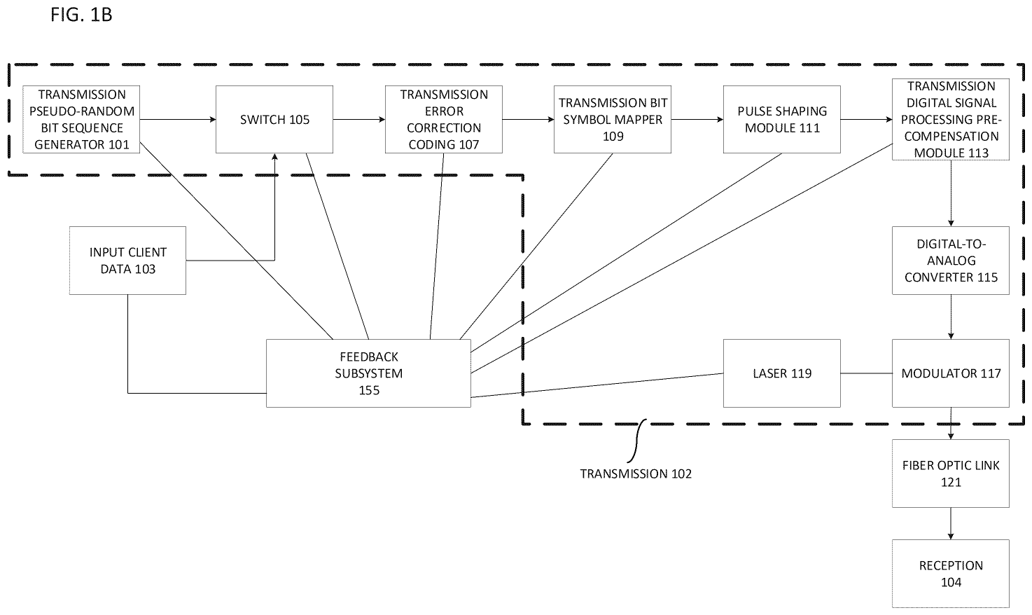

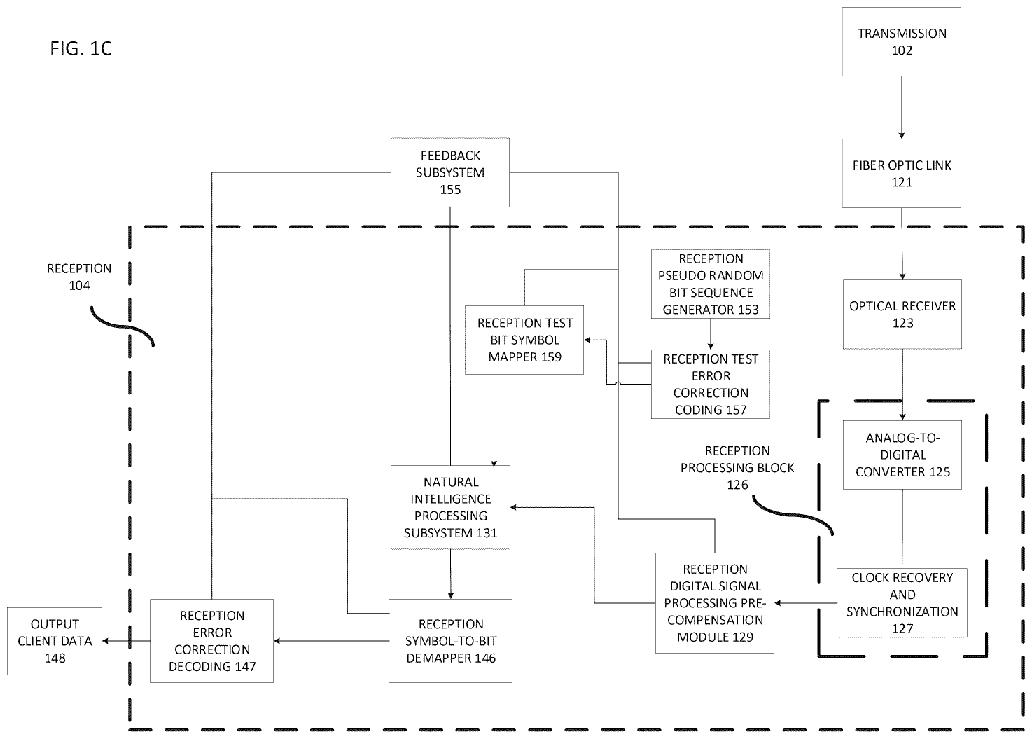

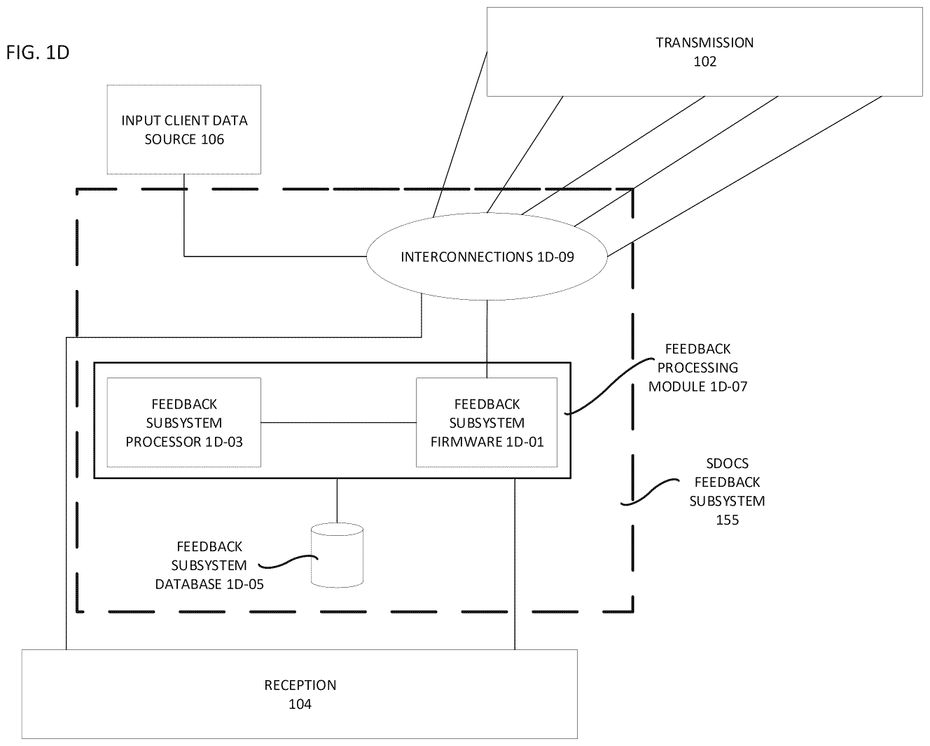

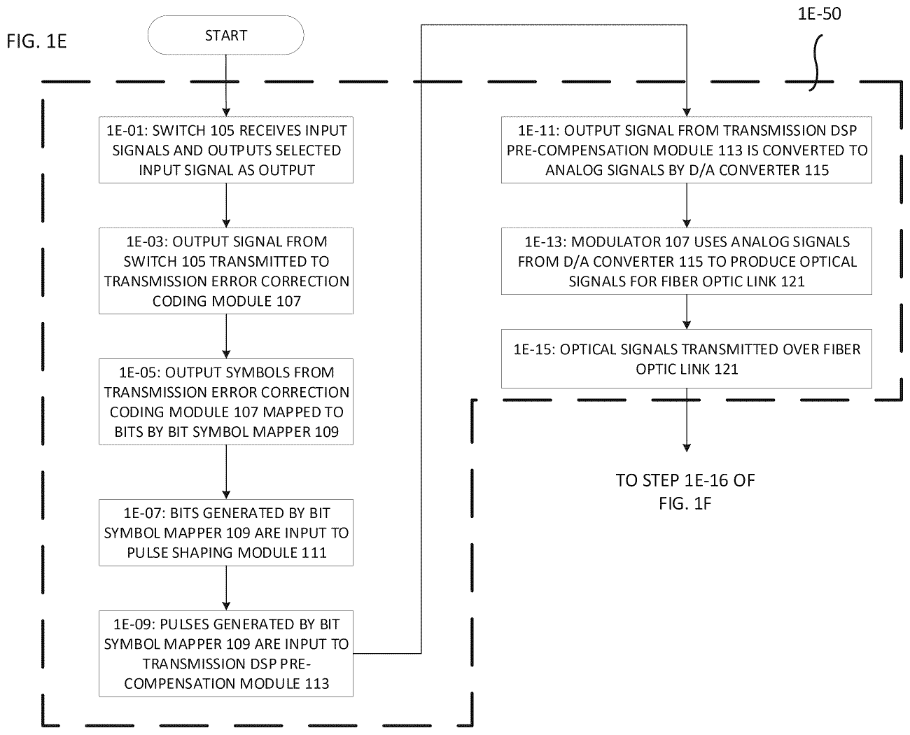

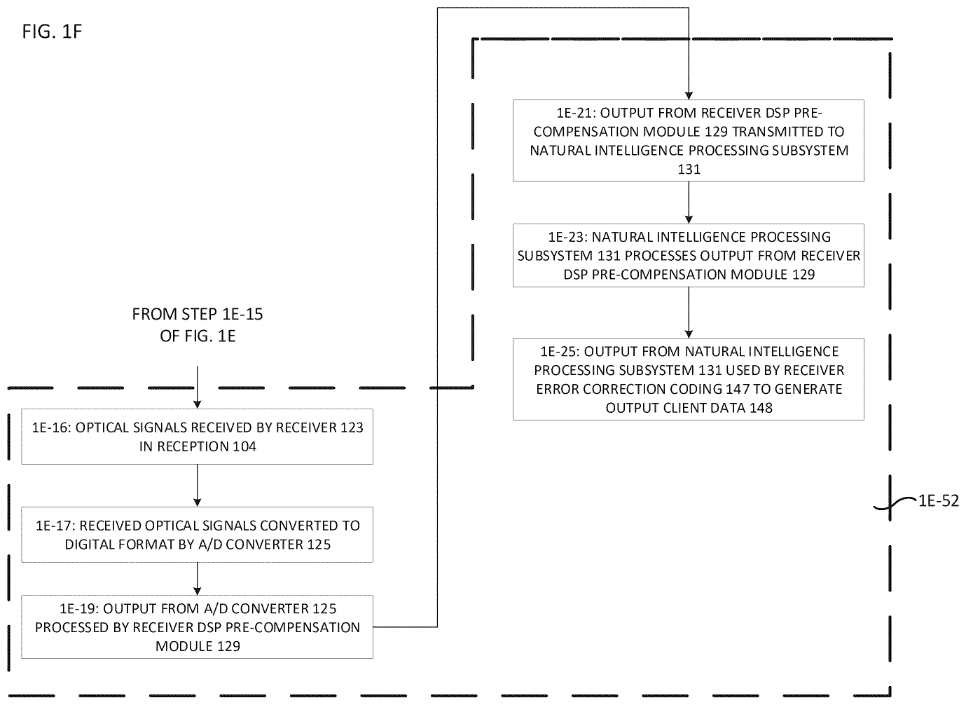

FIG. 1A illustrates an example embodiment of an SDOCS 100 which integrates NI. In SDOCS 100, transmission 102 is coupled to reception 104 via fiber optic link 121. Then, input client data 103, which has an associated bit rate and originating from input client data source 106 is sent to transmission 102, where it is processed and converted into optical signals and transmitted via fiber optic link 121 to reception 104. At reception 104, the received optical signals are then converted and processed to produce output client data 148.

SDOCS 100 comprises SDOCS feedback subsystem 155 which, based on the functioning and performance metrics of fiber optic link 121, acts to adjust parameters related to transmission 102, input client data source 106 and reception 104.

FIGS. 1B, 1C and 1D show example embodiments of transmission 102, reception 104 and SDOCS feedback subsystem 155, respectively.

FIGS. 1E and 1F show an example embodiment of signal flow in SDOCS 100 for client data from input to output. FIG. 1E shows the transmission sequence 1E-50, and FIG. 1F shows a reception sequence 1E-52. Transmission sequence 1E-50 of FIG. 1E comprises steps 1E-01, 1E-03, 1E-05, 1E-07, 1E-09, 1E-11, 1E-13 and 1E-15. Reception sequence 1E-52 of FIG. 1F comprises steps 1E-16, 1E-17, 1E-19, 1E-21, 1E-23 and 1E-25.

FIG. 1B shows an example embodiment of transmission 102. Referring to FIG. 1B in conjunction with FIG. 1E: transmission 102 comprises:
transmission pseudo-random bit sequence (PRBS) generator 101,
switch 105,
transmission error correction coding module 107,
transmission bit symbol mapper 109,
pulse shaping module 111,
transmission digital signal processing pre-compensation module 113, digital-to-analog converter 115,
modulator 117, and
laser 119.

Transmission PRBS generator 101 generates PRBS using techniques known to those of ordinary skill in the art. In some embodiments, transmission PRBS generator 101 is synchronized with reception PRBS generator 153, which will be discussed later. This synchronization enables both transmission and reception PRBS generators to generate the same PRBSes at the transmission and reception, so as to facilitate training and BER measurement. Techniques to synchronize transmission PRBS generator 101 with reception PRBS generator 153 are known to those of ordinary skill in the art and will not be discussed here. The combination of transmission PRBS generator operating in synchronization with reception PRBS generator 153 overcomes a major issue encountered in systems that require training, such as machine learning and AI systems, which is the reliance on pre-existing large databases of training data. This combination enables the generation of training data on the fly, which is useful for real-time applications and ensures that the system can adapt and train dynamically, enhancing responsiveness and effectiveness in various operational scenarios.

Switch 105 is communicatively coupled to transmission PRBS generator 101, and input client data source 106 at the input end.

In step 1E-01 of FIG. 1E: switch 105 receives the following signals as inputs:
Output from transmission PRBS generator 101, and
Input client data 103 from input client data source 106.

Depending on whether the SDOCS 100 is in training mode or steady state mode, switch 105 selects one of the above input signals and outputs the selected input signal as an output signal. In steady state mode, the SDOCS 100 operates using input client data 103. In training mode, the SDOCS 100 operates using the data output from transmission PRBS generator 101 so as to perform training as will be discussed below. The selection of an input signal by switch 105 is also discussed further below.

None of Naghshvarianjahromi 1, Naghshvarianjahromi 2, Naghshvarianjahromi 3 and Naghshvarianjahromi 4 contemplate switching between input client data and training PRBS data generated by transmission PRBS generator 101 using a switch such as switch 105. This switch mechanism is crucial for real-time practical implementation as it ensures SDOCS 100 can switch between input client data and transmission PRBS data depending on whether SDOCS 100 is in steady state mode or training mode, and, therefore, dynamically adapt to changing conditions without requiring constant manual intervention.

In step 1E-03 of FIG. 1E: the output signal from switch 105 is then transmitted to transmission error correction coding module 107. Based on the output signal from switch 105, transmission error correction coding module 107 generates an error correction coded output signal comprising bits using a forward error correction (FEC) coding scheme.

Transmission error correction coding module 107 is communicatively coupled to transmission bit symbol mapper 109. In step 1E-05 of FIG. 1E: transmission bit symbol mapper 109 receives the error correction coded output signal comprising bits generated by transmission error correction coding module 107, and maps these received bits to symbols. This mapping is performed based on a modulation format used by the bit symbol mapper. Techniques to perform mapping are known to those of ordinary skill in the art. Examples of different modulation formats are binary phase-shift keying (BPSK), quadrature phase-shift keying (QPSK), or S-QAM, where S refers to the number of symbols in an alphabet for quadrature amplitude modulation (QAM). Examples of S-QAM are 16-QAM (S=16) and 64-QAM (S=64).

Transmission bit symbol mapper 109 is communicatively coupled to pulse shaping module 111. In step 1E-07 of FIG. 1E: the symbols generated by bit symbol mapper 109 are then input to pulse shaping module 111, where pulses are created based on the symbols transmitted from bit symbol mapper 109.

Pulse shaping module 111 is communicatively coupled to transmission digital signal processing (DSP) pre-compensation module 113. In step 1E-09 of FIG. 1E: the pulses output from pulse shaping module 111 are received by transmission DSP pre-compensation module 113, where pre-compensation techniques are applied to these received pulses to generate an output digital signal. Transmission pre-compensation techniques are known to those of ordinary skill in the art and are not discussed in detail here.

Transmission digital signal processing (DSP) pre-compensation module 113 is communicatively coupled to digital to analog (D/A) converter 115. In step 1E-11 of FIG. 1E: The output digital signal from transmission digital signal processing (DSP) pre-compensation module 113 is then transmitted as an input to D/A converter 115. D/A converter 115 receives these digital signals and converts the received digital signals to analog signals.

D/A converter 115 is communicatively coupled to modulator 107. In step 1E-13 of FIG. 1E: The analog signals output from D/A converter 115 are then transmitted to modulator 107, which is optically coupled to laser 119. Modulator 107 uses the analog signals to modulate light waves output from laser 119, and thereby produce optical signals for transmission over fiber optic link 121.

The operation of laser 119 is known to those of ordinary skill in the art and is not discussed in further detail here. One of ordinary skill in the art would know that in a laser such as laser 119, electrical signals are used to control the light output from laser 119. These controls comprise, for example:
adjusting the power of the light waves produced by laser 119, and
adjusting the frequency of the light waves produced by laser 119.

One or more parameters of the light waves produced by laser 119 are modulated based on the signals produced from D/A converter 115. The modulation of the parameters of the light waves includes but is not limited to, for example:
Modulating the phase of the light waves produced by laser 119,
Modulating the amplitude of the light waves produced by laser 119, and
Modulating the phase and the amplitude of the light waves produced by laser 119.

The operations performed in modulator 107 are known to those of ordinary skill in the art and are not discussed in further detail here.

Modulator 117 is optically coupled to reception 104 via fiber optic link 121. In step 1E-15 of FIG. 1E: the optical signals produced by modulator 117 are transmitted over fiber optic link 121, and received by reception 104.

FIG. 1C shows an example embodiment of reception 104. Referring now to FIGS. 1C and 1E: in step 1E-15 of FIG. 1E, the optical signals are transmitted over fiber optic link 121.

Reception 104 comprises:
Optical receiver 123,
Reception processing block 126,
Reception digital signal processing pre-compensation module 129,
Reception PRBS generator 153,
Reception test error correction coding 157,
Reception test bit symbol mapper 159,
NI processing subsystem 131,
Reception symbol-to-bit demapper 146, and
Reception error correction decoding 147.

Referring now to FIG. 1F: In step 1E-16 of FIG. 1F, the transmitted optical signals are received by optical receiver 123 within reception 104. The process of receiving the transmitted optical signals comprises conversion of the optical signals into electrical signals using processes such as photodetection, where photons are converted into electrons. The operation of optical receivers such as optical receiver 123 are well known to those of ordinary skill in the art and are not discussed in detail here.

Optical receiver 123 is communicatively coupled to reception processing block 126. In step 1E-17 of FIG. 1F: Output signals from optical receiver 123 are output to reception processing block 126. Here, clock recovery and synchronization module 127 recovers the baseband frequency of the pulses output from optical receiver 123. Based on the recovered baseband frequency, the output pulses are sampled and converted to symbols in analog-to-digital (A/D) converter 125.

A/D converter 125 is communicatively coupled to reception digital signal processing (DSP) pre-compensation module 129. In step 1E-19 of FIG. 1F: the output from A/D converter 125 is input to reception DSP pre-compensation module 129, where it is processed. The operation of reception DSP pre-compensation module 129 is known to those of ordinary skill in the art and is not discussed in detail here.

As explained previously, reception PRBS generator 153 is synchronized to transmission PRBS 101 so that the PRBS generated in the transmission is the same as that generated in the reception. As explained previously, this is to facilitate the measurement of BER in training mode.

Reception PRBS generator 153 is communicatively coupled to reception test error correction coding module 157. Reception test error correction coding module 157 is similar to transmission error correction coding module 107. Then, in training mode, the reception test error correction coding module 157 receives the output PRBS from reception PRBS generator 153, and generates an error correction coded output signal comprising bits using an error correction coding scheme. Techniques to perform error correction coding are known to those of ordinary skill in the art. One of ordinary skill in the art would understand that both transmission error correction coding module 107 and the reception test error correction coding module 157 are synchronized to the same error correction coding scheme. Techniques to synchronize are known to those of ordinary skill in the art and are not detailed here.

Reception bit symbol mapper 159 is communicatively coupled to reception test error correction coding module 157. Similar to transmission bit symbol mapper 109, reception bit symbol mapper 159 receives the error correction coded output signal from reception test error correction coding module 157, and maps these received bits to symbols. One of ordinary skill in the art would understand that both transmission bit symbol mapper 109 and reception bit symbol mapper 159 are synchronized to use the same modulation formats for mapping. Techniques to synchronize are known to those of ordinary skill in the art and are not detailed here. Then, the output symbols from reception bit symbol mapper 159 are transmitted to NI processing subsystem 131. The operations described above ensure that in training mode, the output symbols from reception bit symbol mapper 159 are synchronized to the output symbols from transmission bit symbol mapper 109.

Reception DSP pre-compensation module 129 is communicatively coupled to NI processing subsystem 131, and is the counterpart to transmission DSP pre-compensation module 113. Techniques to perform reception DSP pre-compensation are known to those of the ordinary skill in the art and will not be discussed in detail here. In step 1E-21 of FIG. 1F: The output symbols from the processing performed by reception DSP pre-compensation module 129 is transmitted to NI processing subsystem 131.

In step 1E-23 of FIG. 1F, NI processing subsystem 131 receives the output symbols from reception DSP pre-compensation module 129, and performs the necessary operations to carry out its role as the central cognitive brain or cognitive processor in SDOCS 100. In some embodiments, steps 1E-23 and 1E-25, which are described below, are performed in parallel.

In this role, NI processing subsystem 131 controls many of the processes that underpin the transmission and reception of optical signals. NI processing subsystem 131 enhances system intelligence and adaptability. In some embodiments, NI processing subsystem 131 is integrated into a DSP module of an optical transceiver, such as, for example, reception DSP pre-compensation module 129.

NI processing subsystem 131 is communicatively coupled to reception error correction decoding 147. Positioning NI processing subsystem 131 after reception DSP pre-compensation module 129 and before reception error correction decoding 147 in the signal flow allows NI processing subsystem 131 to refine integrity of signals output from reception DSP pre-compensation module 129 prior to error correction. This enables NI processing subsystem 131 to optimize the efficiency and efficacy of the SDOCS 100 even in steady-state.

As shown in FIG. 1C, NI processing subsystem 131 is communicatively coupled to SDOCS feedback subsystem 155. NI processing subsystem 131 provides actions to SDOCS feedback subsystem 155 so as to implement a continuous feedback loop, as will be discussed below.

The strategic placement of NI processing subsystem 131 allows for pre-emptive adjustments and fine-tuning. This enhances the resilience and adaptability of SDOCS 100, ensuring robust communication even in the face of variable network conditions and impairments.

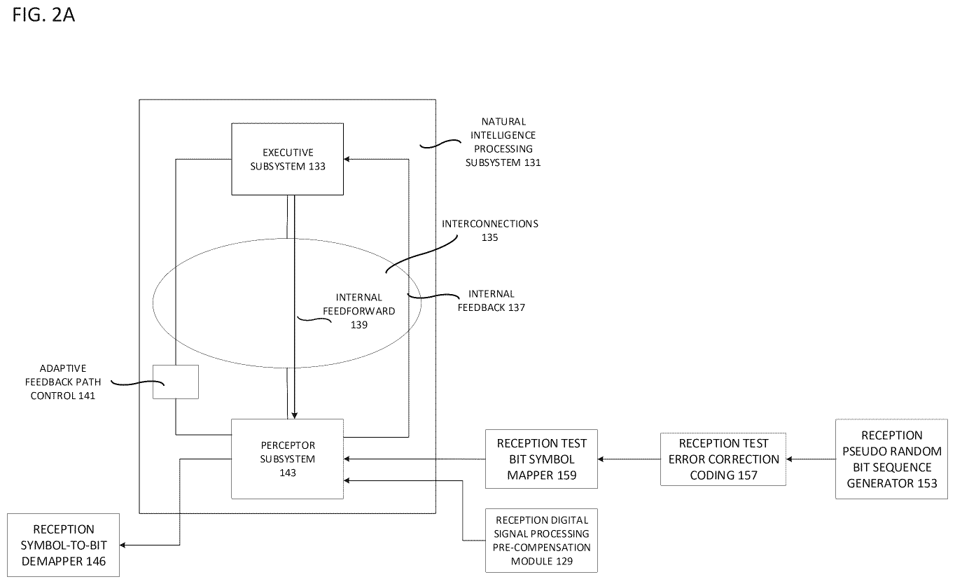

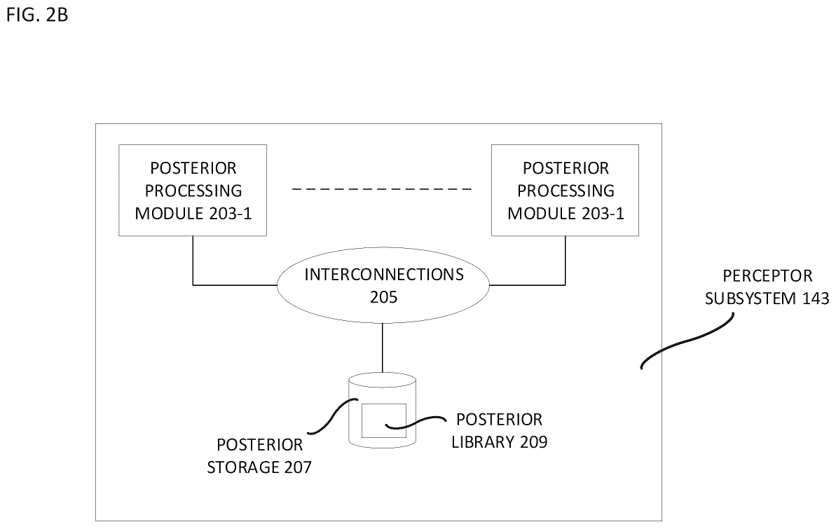

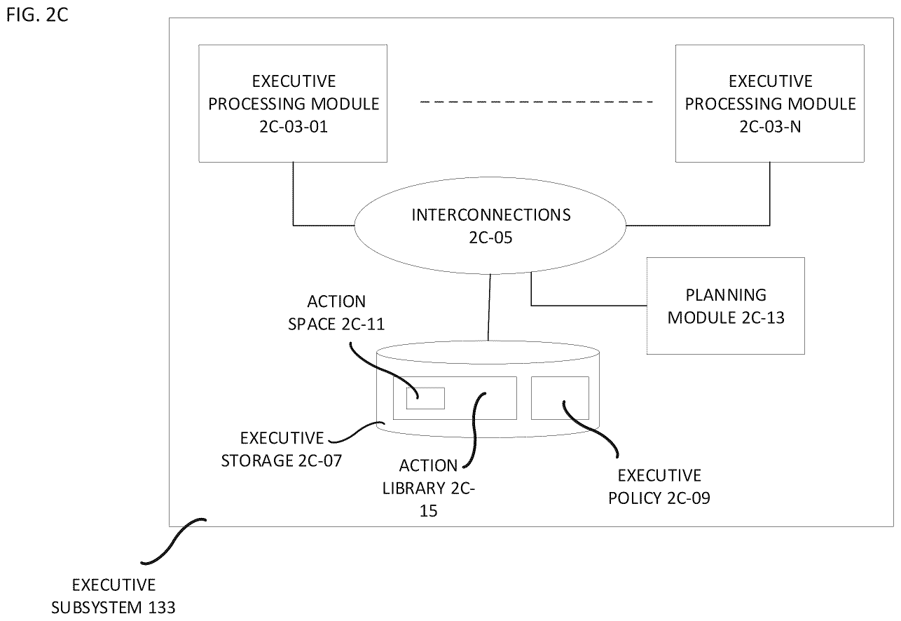

Step 1E-23 of FIG. 1F comprises a series of steps, which are now discussed in detail in conjunction with FIGS. 2A, 2B, 2C, 3, 4A-D, 5A-B and 6. In some embodiments, step 1E-23 comprises a perception-action cycle.

FIG. 2A shows a detailed embodiment of NI processing subsystem 131. In FIG. 2A, perceptor subsystem 143 is communicatively coupled to executive subsystem 133 via interconnections 135.

Channels are set up between perceptor subsystem 143 and executive subsystem 133 via interconnections 135. Examples of these channels are:
Internal feedforward channel 139, which is set up to direct internal feedforward signals from executive subsystem 133 to perceptor subsystem 143; and
Internal feedback channel 143 which is set up to direct internal feedback signals from perceptor subsystem 143 to executive subsystem 133.

Adaptive feedback path control module 141 is communicatively coupled to both perceptor subsystem 143 and executive subsystem 133 using, for example, an adaptive feedback path channel set up via interconnections 135. Adaptive feedback path control module 141 performs the role of dynamically adjusting the system's behavior based on real-time evaluations. Example processes performed include:
processing such as estimating BERs,
relaying the results of these processing operations to executive subsystem 133, and
directing main feedback signals from perceptor subsystem 143 to executive subsystem 133.

In some embodiments, adaptive feedback path control module 141 is implemented in hardware. In other embodiments, adaptive feedback path control module 141 is implemented in software. In yet other embodiments, adaptive feedback path control module 141 is implemented using a combination of software and hardware.

FIG. 2B shows a detailed embodiment of perceptor subsystem 143. In FIG. 2B, perceptor subsystem 143 comprises one or more posterior processing modules 203-1 to 203-N. Posterior processing modules 203-1 to 203-N can be implemented in a variety of ways. In some embodiments, posterior processing modules 203-1 to 203-N are implemented in hardware. In other embodiments, posterior processing modules 203-1 to 203-N are implemented in software. In yet other embodiments, posterior processing modules 203-1 to 203-N are implemented in a combination of hardware and software. In some embodiments, posterior processing modules 203-1 to 203-N comprise a plurality of components.

These one or more posterior processing modules 203-1 to 203-N are communicatively coupled to posterior storage 207 via perceptor subsystem interconnections 205. Perceptor subsystem interconnections 205 are implemented using appropriate communication technologies known to those of ordinary skill in the art.

Posterior storage 207 stores posterior library 209. In some embodiments, posterior storage 207 comprises a database, which is implemented using database techniques known to those of ordinary skill in the art. Data stored in the database is indexed, using techniques known to those of ordinary skill in the art. In some embodiments, the posterior storage 207 is made searchable using techniques known to those of ordinary skill in the art. For example, the posterior storage 207 is implemented as a database.

Posterior library 209 stores a plurality of posterior models. Posterior models are statistical models that capture the SDOCS 100 behavior. In some embodiments, these models are indexed using launch and transmission parameters. These parameters include, for example, data rate, baud rate, link reach, laser wavelength, and other factors affecting the optical channel. These indexing parameters enable posterior library 209 to be searchable. By storing historical data, the posterior library 209 provides the system with the flexibility to respond to new or unexpected conditions and changes. Examples of changes include amplifier noise, or new actions initiated by the executive subsystem 133. Then, when new conditions or changes are proposed or arise, the historical data stored in the posterior library 209 can be searched to identify the closest matching posterior model based on the indexing parameters. As explained previously, this feature was not present in Naghshvarianjahromi 2.

FIG. 2C shows a detailed embodiment of executive subsystem 133. In FIG. 2C, executive subsystem 133 comprises planning module 2C-13. Planning module 2C-13 identifies and extracts a series of prospective actions from the action library 2C-15, which will be explained further below. In some embodiments, initially, the planning module 2C-13 chooses a starting action at the first PAC based on pre-adaptive actions. As explained previously, pre-adaptive actions are predetermined actions designed to be effective before the SDOCS 100 has had a chance to learn or adapt from experience. This differs from the approach used in Naghshvarianjahromi 1, where pre-adaptive actions are not used.

Additionally, the planning module 2C-13 is responsible for updating the type of actions to be taken. Planning module 2C-13 performs an update process through both internal feedback channel 137 and internal feedforward channel 139, forming a shunt cycle. This cycle allows for a dynamic adjustment of the system's parameters in real-time, enabling the NI processing subsystem 131 to adapt to new information or changes in the environment swiftly. For example, planning module 2C-13 sends internal commands to the perceptor subsystem 133 via internal feedforward channel 139 to, for example, modify the precision factor or focus level used by one or more posterior processing modules 203-1 to 203-N. Planning module 2C-13 sends requests to one or more posterior processing modules 203-1 to 203-N to retrieve data such as posterior models from posterior library 209 or discretized data vectors. Retrieved data is sent from one or more posterior processing modules 203-1 to 203-N to planning module 2C-13 via internal feedback channel 137, for use in virtual environmental prediction, as is discussed further below. In some embodiments, planning module 2C-13 is implemented in hardware. In other embodiments, planning module 2C-13 is implemented in software. In yet other embodiments, posterior planning module 2C-13 is implemented in a combination of hardware and software. In some embodiments, planning module 2C-13 comprises a plurality of components interconnected together.

The executive subsystem 133 comprises one or more executive processing modules 2C-03-01 to 2C-03-N. In some embodiments, these one or more executive processing modules 2C-03-01 to 2C-03-N act to perform processing tasks in the executive subsystem 133 which are not performed by planning module 2C-13. In other embodiments, these one or more executive processing modules 2C-03-01 to 2C-03-N act to support planning module 2C-13, when planning module 2C-13 performs its processing tasks.

In some embodiments, one or more executive processing modules 2C-03-01 to 2C-03-N is implemented in hardware. In other embodiments, one or more executive processing modules 2C-03-01 to 2C-03-N is implemented in software. In yet other embodiments, one or more executive processing modules 2C-03-01 to 2C-03-N is implemented in a combination of hardware and software. In some embodiments, one or more executive processing modules 2C-03-01 to 2C-03-N comprise a plurality of components interconnected together.

The executive subsystem 133 comprises executive storage 2C-07. Executive storage 2C-07 is implemented using storage techniques known to those of ordinary skill in the art. In some embodiments, executive storage 2C-07 comprises a database implemented using techniques known to those of ordinary skill in the art. Executive storage 2C-07 stores action space 2C-11, action library 2C-15 and executive policy 2C-09. In some embodiments, data stored in executive storage 2C-07 is indexed, using techniques known to those of ordinary skill in the art. In some embodiments, executive storage 2C-07 is searchable.

Action library 2C-15 comprises action space 2C-11, which in turn comprises the set of all possible actions available to take in response to different conditions or scenarios. In some embodiments, the set of all possible actions available comprises pre-adaptive actions, which are predetermined actions designed to be effective before the system has had a chance to learn or adapt from experience. In some embodiments, the actions in action space 2C-11 are indexed. Action space 2C-11 further comprise environmental actions and internal commands. Environmental actions and internal commands will be further explained below, along with examples.

Executive policy 2C-09 outlines the objectives that the NI aims to achieve using the PAC. Executive policy 2C-09 sets the desired targets for SDOCS 100. In some embodiments, these targets comprise a balance between accurate cognitive decision-making and the associated computational costs of achieving that accuracy. Policies are either simple or complex based on the goals and the operational context of the NI.

To illustrate, the executive policy 2C-09 sets a goal known as the focus level accuracy threshold, which defines the accuracy objective of the NI processing subsystem 131 decision-making at a specific focus level m while staying within the desired complexity threshold. The focus level m provides an indication of context depth. In some embodiments, the focus level m is the number of received symbols prior to a received symbol, as will be explained below. The focus level accuracy threshold is also referred to as the ATₘ, and these two terms are used interchangeably below. In some embodiments, the ATₘ at different focus levels reflect the different computational complexity requirements at these levels. For example, at the focus level m=1 the ATₘ is higher than at base focus level m=0, to recognize that the cost of computational complexity due to the more detailed modeling required at the higher level necessitates a higher accuracy to compensate. This adaptive mechanism enables the NI processing subsystem 131 to optimize performance based on the trade-offs between accuracy and computational resources, thereby making more informed decisions that align with the set policy goals. In some embodiments, the focus level accuracy threshold is set externally by clients or parties who have the necessary access credentials.

Planning module 2C-13, executive processing modules 2C-03-01 to 2C-03-N and executive storage 2C-07 are coupled to each other via executive subsystem interconnections 2C-05. Executive subsystem interconnections 2C-05 are implemented using appropriate communication technologies known to those of ordinary skill in the art.

As explained above, in some embodiments, steps 1E-23 and 1E-25, which is described below, are performed in parallel. Then, for example:
a copy of the output signal from reception DSP pre-compensation module 129, which comprises symbols is made by one or more posterior processing modules 203-1 to 203-N; or
some portion of the output signal from reception DSP pre-compensation module 129 is split from the output signal by one or more posterior processing modules 203-1 to 203-N.

Either the copy or the split portion is then used by one or more posterior processing modules 203-1 to 203-N to perform the operations within steps 1E-23.

The output signal from reception DSP pre-compensation module 129 is then sent to reception symbol-to-bit demapper 146 to perform step 1E-25 as is described below.

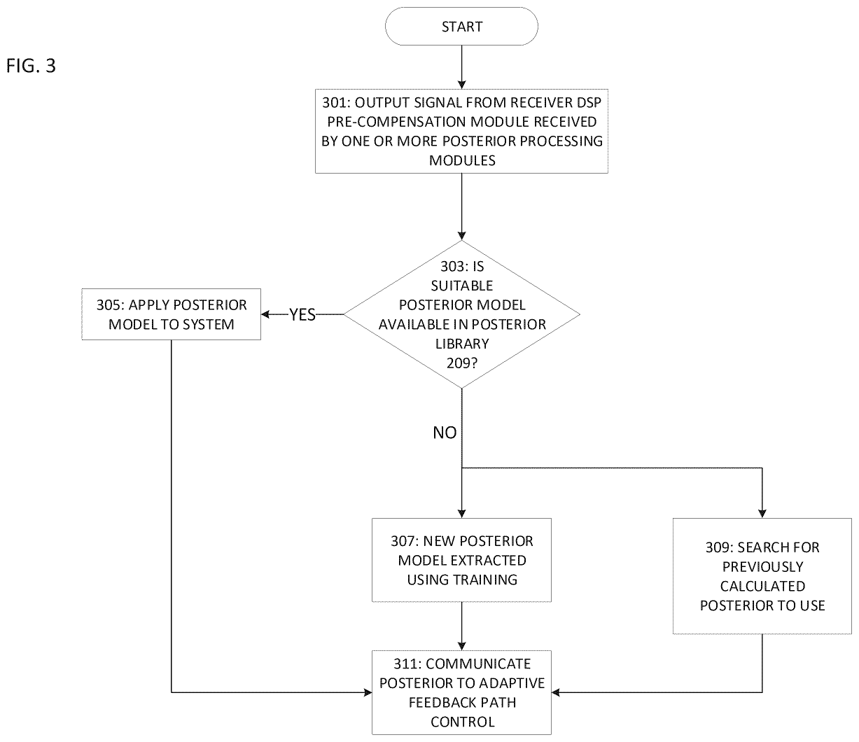

As part of step 1E-23 of FIG. 1E, perceptor posterior processing is performed. An example embodiment of a perceptor posterior processing flow is illustrated in FIG. 3. As explained previously, Naghshvarianjahromi 2 does not have this processing flow. In step 301 of FIG. 3 the output signal from reception DSP pre-compensation module 129 comprising symbols is received by one or more posterior processing modules 203-1 to 203-N.

Within the context of a PAC, the output signal from reception DSP pre-compensation module 129 comprising symbols represents the perceptions. Based on these perceptions, appropriate actions are chosen, as explained below.

In step 303 one or more posterior processing modules 203-1 to 203-N then communicate with posterior storage 207 to search posterior library 209 with the aim of finding a suitable posterior model which captures the behavior of SDOCS 100. As previously explained, in some embodiments, this comprises searching the parameters used to index the posterior model to find the closest match to the current system parameters. For example, when:
a data rate of 210 Gbps is used in the SDOCS,
posterior library 209 does not yet have a posterior model specific to this rate, and
the closest matching posterior model is for a data rate of 200 Gbps, then the posterior model corresponding to a 200 Gbps data rate is retrieved from the library.

When a suitable posterior model is found in step 303, this posterior model is applied to the current operational parameters of the system in step 305.

When a suitable posterior model is not found in step 303, in some embodiments, in step 307 one or more posterior processing modules 203-1 to 203-N initiate the extraction of a new posterior model to minimize the estimated bit error rate (BER), which is a critical performance metric in optical communications; by extracting a fitting using model using training data sets comprising PRBS data. This stands in contrast to the approach used in Naghshvarianjahromi 4, where a database is used for training rather than PRBS data. As explained previously, using PRBS data solves a major issue faced by systems which require training such as machine learning and AI systems, as it removes the need to rely on large databases of training data.

Then, training data comprising PRBS data generated by transmission PRBS generator 101 is used to extract a fitting posterior model. As explained previously, transmission PRBS generator 101 works in synchronization with reception PRBS generator 153 to produce the same data. Processes to generate the PRBS data and synchronize the two PRBS generators are known to those of ordinary skill in the art and will not be discussed in detail.

As is customary in systems which use training, some portion of the training PRBS data is set aside for testing, and not used for model training. An example is where 20% of the data is set aside for testing, and the remaining 80% of the data is used for training. In some embodiments, between 60% and 90% of the data is used for training, and the remaining portion is used for testing.

In other embodiments, “leave k % out cross-validation” is performed. Then, the training data set is split into (100/k) portions, and (100/k) iterations of training and testing are performed, In each iteration, a different one of the portions is left out from training and used for testing, and the remaining portions are used for training. For example, when k=20%, the training data set is split into

$$( \frac{100}{20} ) = 5$$

portions and 5 iterations of training and testing are performed. In each iteration, a different one of the 5 portions of the training data is left out from training and used for testing, and the remaining 4 portions are used for training. This approach lowers the chance of overfitting. One of ordinary skill in the art would understand that k % is set based on, for example, previous results.

This newly identified posterior model is then stored in the posterior library 209 for future reference and employed in subsequent decision-making processes.

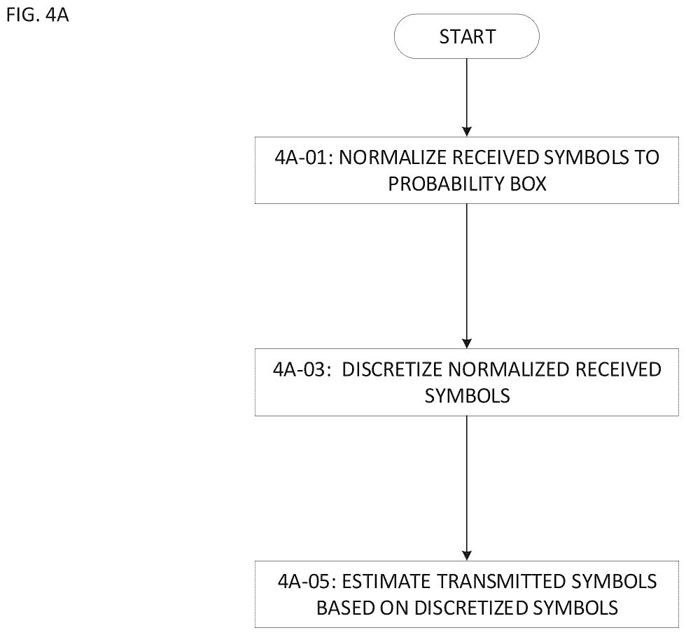

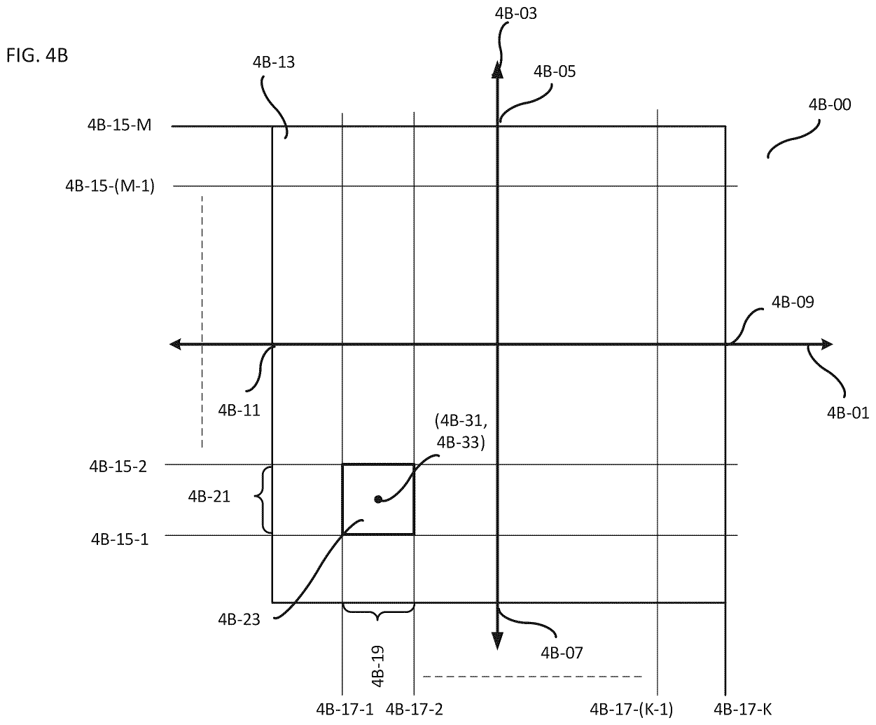

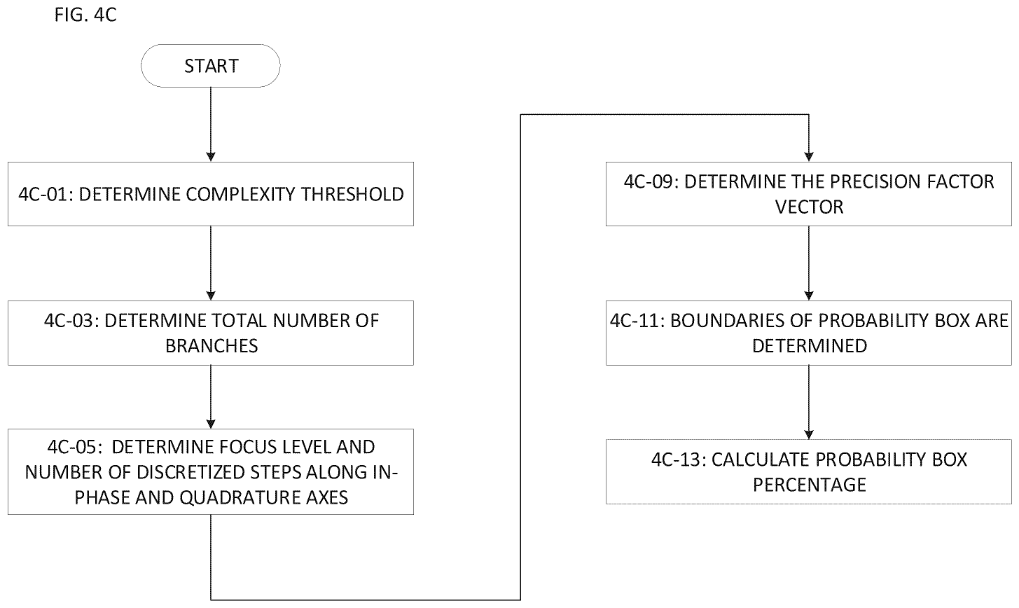

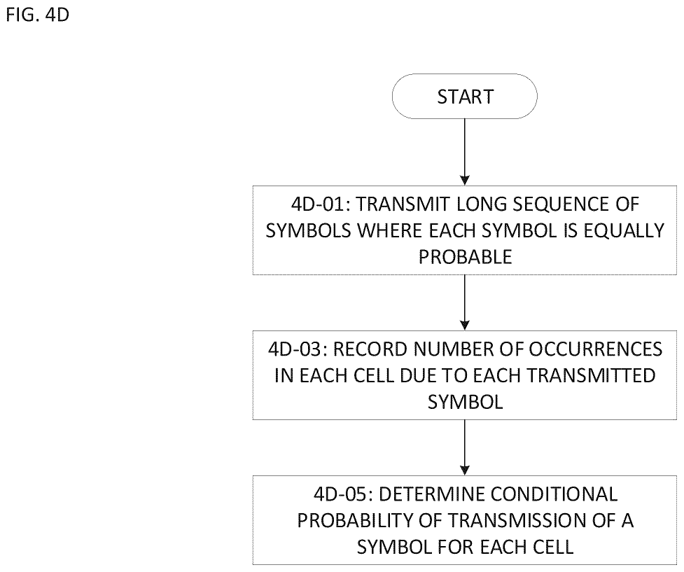

FIG. 4A shows an example embodiment of a posterior extraction processing flow using training, performed by posterior processing modules 203-1 to 203-N for a focus level, m.

As explained previously, the output signal from reception DSP pre-compensation module 129 comprises a plurality of symbols. This received plurality of symbols spans a broad spectrum of values. In step 4A-01, the received plurality of symbols is normalized to a probability box, to reduce the resulting complexity.

The process of normalization is described below with further reference to the signal space diagram in FIG. 4B. In FIG. 4B, signal space 4B-00 is spanned by in-phase axis 4B-01 and quadrature axis 4B-03. Probability box 4B-13 is defined in space 4B-00, wherein values that fall within the following boundaries are considered to lie within the box:
In-phase boundaries: In-phase minimum 4B-11 and in-phase maximum 4B-09; and
Quadrature boundaries: Quadrature minimum 4B-07 to quadrature maximum 4B-05.

The probability box percentage denotes the proportion of the received plurality of symbols that fall within the probability box. In some embodiments, the in-phase and quadrature boundaries are determined based on a probability box percentage threshold. For example, when the probability box percentage threshold is 95%, then the in-phase and quadrature boundaries are set accordingly to obtain a probability box percentage at or above this probability box percentage threshold. In some embodiments, the probability box percentage is determined based on the estimated BER, as explained in, for example, Naghshvarianjahromi 1. As explained in Naghshvarianjahromi 1, estimated BER is directly correlated with probability box percentage, which in turn is inversely correlated to probability box size. Then, the probability box size is increased to reduce BER. However larger probability box size leads to higher computational cost, as will be explained below. Then, in some embodiments, the probability box size is set so as to achieve a threshold BER while keeping computational cost low.

In other embodiments, the in-phase and quadrature boundaries are set based on the available memory. This is useful when, for example, the perceptor subsystem 143 is implemented on a chip, such as a field programmable gate array (FPGA) or application-specific integrated circuit (ASIC), where storage capacity is limited. A process to set the in-phase and quadrature boundaries based on available memory is explained below. The relationship between storage capacity and the probability box is explained further below.

Then, for received symbols that fall within the probability box 4B-13, the normalized received symbols have the same in-phase and quadrature values as the received symbol. For received symbols that fall outside probability box 4B-13, the normalized received symbols take on the in-phase and quadrature values of the nearest boundaries. An example is demonstrated below. In this example, probability box 4B-13 has the following boundaries:
the in-phase minimum 4B-11 is set to −3,
the in-phase maximum 4B-09 is set to 3,
the quadrature minimum 4B-07 is set to −3j, and
the quadrature maximum 4B-05 is set to 3j.

Then, when the symbol 7-5j which falls outside the probability box, is received, it is normalized to the nearest point on the boundary of the probability box, which is 3-3j.

In some embodiments, a probability box such as probability box 4B-13 is defined for each intermediate focus level i where i is between 0 and m, and PAC k. Then, the boundaries for focus level m for PAC k, are hereinafter referred to as follows:
The in-phase minimum, such as in-phase minimum 4B-11, is referred to as

$${x}_{m i n}^{k , i} ,$$

The in-phase maximum, such as in-phase maximum 4B-09, is referred to as

$${x}_{m a x}^{k , i} ,$$

The quadrature minimum, such as quadrature minimum 4B-07, is referred to as

$${y}_{m i n}^{k , i} ,$$

The quadrature maximum, such as quadrature maximum 4B-05, is referred to as

$${y}_{ma x}^{k , i} .$$

The normalized received symbol is hereinafter referred to as

$${\overline{Y}}_{n}^{k , m} ,$$

where:
k is defined as the perception-action cycle (PAC) number,
n is the index of the current symbol,
m represents the focus level for perception-action cycle (PAC) number k, where m ranges from 0 to M, the maximum focus level. As explained previously, the focus level provides an indication of context depth. In some embodiments, the focus level m is the number of received symbols prior to received symbol n, which is used to predict the transmitted symbol n.

The use of focus level stands in contrast to that of Naghshvarianjahromi 1, which focuses on immediate states without in-depth monitoring.

Normalized received symbol

$${\overline{Y}}_{n}^{k , m}$$

is then used for further processing.

In step 4A-03, normalized received symbol

$${\overline{Y}}_{n}^{k , m}$$

is discretized. Processes and equations to set the discretization parameters are now described.

Axis discretizations are performed for the in-phase and quadrature axes. In some embodiments, for each intermediate focus level i between 0 and the focus level m, an in-phase discretization step

$$Δ {x}_{i}^{k}$$

and the quadrature discretization step

$$Δ {y}_{i}^{k}$$

are defined for PAC k as follows:

$$Δ {x}_{i}^{k} = \frac{{x}_{ma x}^{k , i} - {x}_{m i n}^{k , i}}{{N}_{x}^{k , i}} \qquad ( Equation 1 )$$

$$Δ {y}_{i}^{k} = \frac{{y}_{ma x}^{k , i} - {y}_{m i n}^{k , i}}{{N}_{y}^{k , i}}$$

where

$${N}_{x}^{k , i}$$

is the number of in-phase discretization steps for PAC k and intermediate focus level i, and

$${N}_{y}^{k , i}$$

is the number of quadrature discretization steps for PAC k and intermediate focus level i.

In some embodiments, the in-phase discretization step is the same as the quadrature discretization step. In other embodiments, the in-phase discretization step is not equal to the quadrature discretization step.

Then, the axes are discretized based on the discretization steps. For example, in FIG. 4B, in-phase axis 4B-01 is discretized into K discretized in-phase points, wherein consecutive discretized in-phase points are separated by an in-phase discretization step. Then K is equal to

$${N}_{x}^{k , i} .$$

For example, consecutive discretized in-phase points 4B-17-1 and 4B-17-2 on the in-phase axis 4B-01 are separated by in-phase discretization step 4B-19.

Similarly, quadrature axis 4B-07 is discretized into M discretized quadrature points, wherein consecutive discretized quadrature points are separated by a quadrature discretization step. M is then equal to

$${N}_{y}^{k , i} .$$

For example, consecutive discretized quadrature points 4B-17-1 and 4B-17-2 are separated by quadrature discretization step 4B-21.

Based on the discretization of the in-phase and quadrature axes, discretization cells are formed. For example, referring to FIG. 4B, discretization cell 4B-23 is bounded by 4B-17-1 and 4B-17-2 on the in-phase axis, and 4B-15-1 and 4B-15-2 on the quadrature axis. Each cell has dimensions

$$( Δ {x}_{i}^{k} \times Δ {y}_{i}^{k} ) .$$

Then a precision factor is assigned for each intermediate focus level i for PAC k. In some embodiments, an in-phase precision factor is calculated based on the in-phase discretization step, and a quadrature discretization step is calculated based on the quadrature discretization step.

In some of the embodiments where the in-phase discretization step is the same as the quadrature discretization step, the in-phase precision factor is equal to the quadrature precision factor. This common precision factor is denoted as

$${PF}_{i}^{k} .$$

An example relationship between the precision factor, in-phase discretization step and quadrature discretization step for embodiments where the in-phase discretization step is equal to the quadrature discretization step is given as:

$${PF}_{i}^{k} = 10 Δ {x}_{i}^{k} = 10 Δ {y}_{i}^{k} , 0 \leq i \leq m , \qquad ( Equation 2 )$$

Then, a precision factor vector for focus level m and PAC k, PF^{k,m} which has its elements the common precision factor for each intermediate focus level i is denoted as:

$${PF}^{k , m} = [ {PF}_{0}^{k} , {PF}_{1}^{k} , ⋯ , {PF}_{i}^{k} , ⋯ , {PF}_{m}^{k} ] \qquad ( Equation 3 )$$

The number of decision tree branches

$${F}_{i}^{k}$$

at each intermediate focus level i is computed as the product of

$${N}_{x}^{k , i} and {N}_{y}^{k , i} :$$

$${F}_{i}^{k} = {N}_{x}^{k , i} {N}_{y}^{k , i} \qquad ( Equation 4 )$$

Using Equations 1 and 2,

$${N}_{x}^{k , i} and {N}_{y}^{k , i}$$

can be computed based on the precision factor are shown below:

$${N}_{x}^{k , i} = \frac{10 ( {x}_{max}^{k , i} - {x}_{min}^{k , i} )}{{PF}_{i}^{k}} \qquad ( Equation 5 )$$

$${N}_{y}^{k , i} = \frac{10 ( {y}_{max}^{k , i} - {y}_{min}^{k , i} )}{{PF}_{i}^{k}}$$

Therefore, for a probability box, a lower precision factor leads to a higher number of discretization steps, which then leads to a higher number of decision tree branches at each intermediate focus level. This has an impact on computational cost as will be seen below.

The total number of branches for the focus level m, hereinafter referred to as

$${F}_{m}^{total , k} ,$$

is calculated by the product of the branches at each level:

$${F}_{m}^{total , k} = {\prod }_{i = 0}^{m} {F}_{i}^{k} \qquad ( Equation 6 )$$

One of ordinary skill in the art would recognize that

$${F}_{m}^{total , k}$$

grows exponentially with the focus level m. Since the memory needed for storage is related to

$${F}_{m}^{total , k} ,$$

one of ordinary skill in the art would also recognize that the memory needed for storage also grows exponentially with focus level m.

One of ordinary skill in the art would also recognize from the above that a lower precision factor leads to a higher

$${F}_{m}^{total , k}$$

which leads to higher memory requirements. However, as explained in Naghshvarianjahromi 1, a lower precision factor leads to lower BER. Therefore, there is a trade-off between lowering BER and memory requirements.

In some embodiments,

$${F}_{m}^{total , k}$$

is constrained by a predefined complexity threshold based on the available memory capacity, that is:

$${F}_{m}^{total , k} \leq Complexity threshold \qquad ( Equation 7 )$$

One of ordinary skill in the art would recognize from the equations above that there are a number of approaches to set each of the measures denoted above, and tradeoffs with each set of parameters. An example embodiment of a process to determine discretization parameters starting from a known complexity threshold is shown in FIG. 4C.

In step 4C-01, the complexity threshold is determined. In some embodiments, this is performed based on the available memory. The available memory is, for example, memory available on a hard disk or for storage in a random access memory (RAM).

In step 4C-03, the total number of branches is determined based on the complexity threshold, for example, the equation described above.

In step 4C-05, the focus level m is set, and for each intermediate focus level i between 0 and m,

$${N}_{x}^{k , i} and {N}_{y}^{k , i}$$

are determined. In some embodiments,

$${N}_{x}^{k , i} and {N}_{y}^{k , i}$$

are set equal to each other for all intermediate focus levels. In some embodiments, since the total number of branches grows exponentially with focus level m, then focus level m is set based on the natural logarithm of the total number of branches determined in step 4C-03.

In step 4C-09, the elements of the precision factor vector PF^{k,m} are determined.

In step 4C-11 based on the elements of precision factor vector determined in step 4C-09 and the

$${N}_{x}^{k , i} and {N}_{y}^{k , i}$$

determined in step 4C-07: the discretization steps

$$Δ {x}_{i}^{k} and Δ {y}_{i}^{k}$$

are determined, then the in-phase and quadrature boundaries of the probability box are determined for each intermediate focus level i from 0 to m.

In step 4C-13 the probability box percentage is calculated. In some embodiments, this is compared to a probability box percentage threshold to determine whether the calculated probability box percentage is acceptable.

An example of the operation of FIG. 4C for a particular embodiment is now detailed. In step 4C-01, a complexity threshold of 10⁷ memory elements is set based on, for example, available memory.

Then, in step 4C-03, the total number of branches is:

$${F}_{m}^{total , k} \leq 1 {0}^{7} \qquad ( Equation 8 )$$

For step 4C-05: for this embodiment

$${N}_{x}^{k , i}$$

is set equal to

$${N}_{y}^{k , i} = N .$$

### Then:

$${F}_{m}^{total , k} = {\prod }_{i = 0}^{m} {F}_{i}^{k} \qquad ( Equation 9 )$$

$${F}_{m}^{total , k} = {N}^{2 ( m + 1 )}$$

$$m \leq \frac{ln ( 1 {0}^{7} )}{2 ln ( N )} - 1$$

$$m \leq \frac{16.11}{2 ln ( N )} - 1$$

Since the combination of m=1 and N=42 fulfils this requirement, in this embodiment, m is set to 1 and N is set to 42. Then,

$${N}^{2 ( m + 1 )} = {( 42 )}^{2 ( 2 )} = 3 , 111 , 696$$

memory elements are needed, which is less than 10⁷.

In step 4C-09, PF^{k,m} is set to

$$[ {PF}_{0}^{k} , {PF}_{1}^{k} ] = [ 5 , 5 ] .$$

In step 4C-11, the discretization steps

$$Δ {x}_{i}^{k} and Δ {y}_{i}^{k}$$

are calculated as 0.5 using, for example, Equation 2. Then, since N=42, from Equation 1,

$$( {x}_{m ax}^{k , i} - {x}_{m i n}^{k , i} ) = 42 \times 0.5 = 21 .$$

### Similarly

$$( {y}_{m ax}^{k , i} - {y}_{m i n}^{k , i} ) = 21 .$$

Based on this and centering the PB on the origin,

$$\vert {x}_{m ax}^{k , i} \vert = \vert {x}_{m i n}^{k , i} \vert = \vert {y}_{m ax}^{k , i} \vert = \vert {y}_{m i n}^{k , i} \vert = 10.5 ,$$

for i=0 and 1.

Then in step 4C-13, the PB percentage is calculated for the PB defined above, where:

$${x}_{m i n}^{k , i} = - 10.5 \\ {x}_{m ax}^{k , i} = 1 0.5 , \\ {y}_{m i n}^{k , i} = - 10.5 j , \\ and \\ {y}_{m ax}^{k , i} = 10.5 j .$$

One of ordinary skill in the art would know that the example embodiment demonstrated in FIG. 4C is one example embodiment, and many embodiments are possible. In another example embodiment:
The probability box percentage threshold is set based on, for example, a BER threshold as explained previously;
The probability box boundaries are defined so as to achieve a probability box percentage at or above the probability box percentage threshold, as explained previously;
PF^{k,m} and the discretization steps are calculated;
m and N are set based on the calculation of PF^{k,m},
the total number of branches

$${F}_{m}^{total , k}$$

and memory requirement is computed and compared to the complexity threshold, and
The BER is estimated and compared to the BER threshold to ensure that the BER threshold requirement is met.

The process of discretization is now explained. Each normalized received symbol

$${\overline{Y}}_{n}^{k , m}$$

is converted to a discretized data symbol element for each intermediate focus level i between 0 and m based on the location of the discretized cell it falls into in signal space 4B-00. This discretized data symbol element is hereinafter referred to as

$${\hat{Y}}_{n - i}^{k} ( {PF}_{i}^{k} ) .$$

For example, referring to FIG. 4B, when a normalized received symbol falls into cell 4B-23, it is converted to a discretized data symbol element comprising in-phase and quadrature co-ordinates assigned to cell 4B-23. In some embodiments, the mid points between the boundaries are assigned to the cell. Referring to cell 4B-23 of FIG. 4B the midpoint 4B-31 between 4B-17-1 and 4B-17-2; and the midpoint 4B-33 between 4B-15-1 and 4B-15-2 are assigned to cell 4B-23. Then any normalized received symbol which falls into the cell is converted to a discretized data symbol element comprising these assigned co-ordinates (4B-31, 4B-33).

A discretized data vector

$${\hat{Y}}_{n}^{k , m}$$

is then formed, comprising the discretized data symbol elements for all the intermediate focus levels between 0 and m, defined as:

$${\overline{Y}}_{n}^{k , m} = [ {\hat{Y}}_{n - m}^{k} ( {PF}_{m}^{k} ) , {\hat{Y}}_{n - m + 1}^{k} ( {PF}_{m - 1}^{k} ) , … , {\hat{Y}}_{n - i}^{k} ( {PF}_{i}^{k} ) , … , {\hat{Y}}_{n}^{k} ( {PF}_{0}^{k} ) ]$$

The discretized data vector

$${\hat{Y}}_{n}^{k , m}$$

and the precision factor vector PF^{k,m} are then used for further processing in step 4A-05.

In step 4A-05, the perceptor subsystem 143 creates an estimate

$${\hat{X}}_{n}^{k}$$

of the transmitted symbol

$${X}_{n}^{k}$$

based on the discretized data vector

$${\hat{Y}}_{n}^{k , m} .$$

In some embodiments, as explained above, reception PRBS generator 153 is synchronized to transmission PRBS generator 101 to generate the same PRBS. Then, as explained above, the reception test error correction coding module 157 receives the output PRBS from reception PRBS generator 153, and generates an error correction coded output signal which is synchronized to the same error correction coding scheme as in transmission error correction coding module 107.

As explained above, reception bit symbol mapper 159 receives the error correction coded output signal from reception test error correction coding module 157, and maps these received bits to symbols. As also explained above, transmission bit symbol mapper 109 and reception bit symbol mapper 159 are synchronized to use the same modulation formats for mapping. This ensures that the output symbols

$${\hat{X}}_{n}^{k}$$

from reception bit symbol mapper 159 are synchronized to the output from transmission bit symbol mapper 109 in training mode. These output symbols

$${\hat{X}}_{n}^{k}$$

are then transmitted to NI processing subsystem 131,

The probability

$$P ( {X}_{n}^{k} \vert {Y}_{n}^{k , m} )$$

is approximated using the Monte Carlo method by considering the probability of

$${\hat{X}}_{n}^{k}$$

for a given discretized data vector

$${\hat{Y}}_{n}^{k , m} ,$$

denoted as

$$P ( {\hat{X}}_{n}^{k} \vert {\hat{Y}}_{n}^{k , m} )$$

In some embodiments, a Bayesian equation such as the approach used in Naghshvarianjahromi 1 is utilized to extract the posterior as follows:

$$\begin{matrix}P ( {X}_{n}^{k} \vert {Y}_{n}^{k , m} ) = \frac{P ( {Y}_{n}^{k , m} \vert {X}_{n}^{k} ) P ( {X}_{n}^{k} )}{P ( {Y}_{n}^{k , m} )} \\ ≅ \frac{P ( {\hat{Y}}_{n}^{k , m} \vert {\hat{X}}_{n}^{k} ) P ( {\hat{X}}_{n}^{k} )}{P ( {\hat{Y}}_{n}^{k , m} )}\end{matrix} \qquad ( Equation 10 )$$

For each cell, computing the probabilities P(.) requires one real division. An estimate of the computational cost is provided as follows: When the symbols

$${X}_{n}^{k}$$

are equally probable, the computational cost for evaluating

$$P ( {X}_{n}^{k} \vert {Y}_{n}^{k , m} )$$

is 3 real divisions per cell. Therefore, the total computational cost for extracting the posterior is

$$3 \times S \times {F}_{m}^{t o t a l , k}$$

real divisions, where S is the number of symbols, and

$${F}_{m}^{t o tal , k}$$

is the number of cells.

In other embodiments, non-Bayesian approaches are utilized. An example embodiment of a non-Bayesian approach is provided below with reference to FIG. 4D. The approach outlined below can result in an improvement in latency compared to the Bayesian approach outlined above.

In step 4D-01, during the training phase, transmission PRBS generator 101 is programmed to produce a bit stream to ensure that a long sequence of symbols

$${\hat{X}}_{n}^{k}$$

where each symbol is equally probable is transmitted by transmission bit symbol mapper 109. As explained previously, reception PRBS generator 153 is synchronized to produce the same bit stream as transmission PRBS generator 101. Then, as explained before, reception test bit symbol mapper 159 is synchronized to produce the same output symbols as transmission bit symbol mapper 109. The sequence of symbols output from reception test bit symbol mapper 159 is received, normalized and discretized to form

$${\hat{Y}}_{n}^{k , m} .$$

In step 4D-03, for each discretized cell, the number of occurrences due to each transmitted symbol is recorded. Referring to FIG. 4B, the number of occurrences within cell 4B-23 due to each transmitted symbol are determined.

In step 4D-05, the probability that a particular symbol was transmitted, given that there is an occurrence in a cell, is estimated for each cell. In some embodiments, the estimation comprises determining the ratio of the number of occurrences within this cell for each transmitted symbol, to the total number of occurrences within the same cell. For example, referring to FIG. 4B, when the transmitted symbol is X_{S}, and for cell 4B-23, the ratio of these two counts provides the posterior probability P(X_{S}|occurrence in cell 4B-23). In general, this posterior probability is calculated as:

$$P ( {\hat{X}}_{n}^{k} = {X}_{s} \vert {\hat{Y}}_{n}^{k , m} ) = \frac{Number of occurrences of {\hat{Y}}_{n}^{k , m} due to {X}_{s}}{Total number of occurrences of {\hat{Y}}_{n}^{k , m}} \qquad ( Equation 11 )$$

Since the denominator is constant for each cell in Equation 11, it does not affect the determination of the maximum posterior. Thus, an estimate of the maximum posterior is provided by finding the transmitted symbol resulting in the highest number of appearances within this cell. Therefore, no division is required, resulting in a lower memory requirement.

Following this, the perceptor subsystem 143 uses the posterior

$$P ( {X}_{n}^{k} \vert {\hat{Y}}_{n}^{k , m} )$$

to select the symbol Xₛ that has the maximum probability for each discretized cell, as shown in equation

$$\overline{X} = {arg max}_{s = 1 , 2 , … , S} \{ P ( {\hat{X}}_{n}^{k} = {X}_{s} \vert {\hat{Y}}_{n}^{k , m} ) \} \qquad ( Equation 12 )$$

where:
S represents the number of symbols in a S-QAM alphabet.

The maximum posterior is stored in posterior library 209. In some embodiments, the maximum posterior is stored as a matrix

$$P max ( \overline{X} , {\hat{Y}}_{n}^{k , m} ) = max \{ P ( {\hat{X}}_{n}^{k} = \overline{X} \vert {\hat{Y}}_{n}^{k , m} ) \} .$$

During data transmission, when the received data, after discretization and normalization, matches a specific cell

$${\hat{Y}}_{n}^{k , m} ,$$

the corresponding X̅ from the matrix

$$P max ( \overline{X} , {\hat{Y}}_{n}^{k , m} )$$

is selected as the most likely transmitted symbol.

By only saving the maximum posterior, the memory requirements are reduced when compared to the Bayesian approach. For example, for 64-QAM, memory requirements are reduced by 64. Moreover, since

$$Pmax ( \overline{X} , {\hat{Y}}_{n}^{k , m} )$$

is evaluated during the training period, symbol estimation during data transmission is expedited.

In the steady-state operation phase, the posterior extraction stage does not incur additional costs since the data is fetched directly from storage memory. The NI's operations generally bypass the need for either multiplications or additions in processing the data. This includes a singular instance during the training phase for calculating

$$Pmax ( \overline{X} , {\hat{Y}}_{n}^{k , m} ) ,$$

which does not demand additions or multiplications.

The above approach is more computationally efficient compared to other fiber optic link nonlinear mitigation methods such as Digital Back Propagation (DBP). For example, DBP processing for a single optical time-division multiplexed (OTDM) frame of 4096 symbols requires an estimated O(MN log₂ N) complex multiplications for M propagation steps. For instance, in a two-span system with one step per span and two samples per symbol, approximately 196,608 complex multiplications are needed. This does not include the continuous computation for each data block and a storage scaling of O(N log₂ N), totaling about 49,152. See, for example, E. Ip and J. M. Kahn, “Compensation of Dispersion and Nonlinear Impairments Using Digital Backpropagation,” in Journal of Lightwave Technology, vol. 26, no. 20, pp. 3416-3425 Oct. 15, 2008.

Since most of the computational effort is necessitated only when channel fluctuations prompt the system to revert to training mode, then in steady state, computational costs are minimal. In comparison, neural network-based mitigation techniques are more computationally intensive and storage intensive. For example, the technique demonstrated in Zhang, F. Yaman, K. Nakamura, et al. “Field and lab experimental demonstration of nonlinear impairment compensation using neural networks,” Nature Communications, vol. 10, 3033, 2019, would require roughly O(N×500) complex multiplications. The storage requirements are also more intensive than the non-Bayesian approach.

This continuous updating and refinement of the posterior library 209 allows for improvement of decision-making capabilities over time, ensuring both adaptability and precision in maintaining optimal network performance.

In other embodiments, when a model cannot be found, in step 309 the one or more posterior processing modules 203-1 to 203-N searches for a previously used posterior model, stored in posterior library 209, which yields the best BER estimation.

By comparing the estimated BER against the stored posterior models, the system identifies the most accurate model or decision rules applied in the past. This process enables the perceptor to refine its predictions and adjustments for future data processing and decision-making, ultimately enhancing the overall reliability and performance of the system.

In some embodiments, each posterior model is indexed in the posterior library 209 using launch and transmission parameters such as:
Transmission power,
Transmission wavelength,
Modulation format,
Baud rate, and
Optical reach.

Then, the searching comprises finding the closest match to the current launch and transmission parameters.

In some embodiments, step 307 and 309 are performed in parallel.

In step 311, the perceptor subsystem 143 relays the selected posterior model to the adaptive feedback path control 141. As explained previously, the adaptive feedback path control 141 estimates BERs. In the steady state, the adaptive feedback path control 141 utilizes an assurance factor derived from the relayed posterior model relayed from the perceptor subsystem 143. When the system is not in steady state, the adaptive feedback path control 141 calculates BER from received training data. In both cases, the estimated or calculated BER is relayed to executive subsystem 133.

Assurance factor is now explained. The assurance factor offers a direct measure of confidence or probability that the system has correctly identified or decided on the transmitted symbol, given the received symbol.

The average assurance factor (AF) for PAC k and symbol n,

$${AF}_{n}^{k} ,$$

is defined as the mean of the posterior probabilities over a discrete time interval L:

$${AF}_{n}^{k} = \frac{{\sum }_{b = n - L}^{n} P ( {X}_{b}^{k} \vert {Y}_{b}^{k , m} )}{L} , n - L \geq m \qquad ( Equation 13 )$$

Where:
L is a number of symbols prior to the current symbol used for calculating the assurance factor,
n represents the current time, and
m denotes the focus level.

The symbol error rate (SER) for PAC k and for symbol n is hereinafter referred to as

$$〈 {SER}_{n}^{k} 〉 .$$

During steady-state, when training data from a PRBS is not available, in some embodiments the NI estimates the SER for the kth Perceptual Adaptive Control (PAC) as the complement of the assurance factor

$${AF}_{n}^{k} ,$$

that is:

$$〈 {SER}_{n}^{k} 〉 = 1 - {AF}_{n}^{k} \qquad ( Equation 14 )$$

The change in the assurance factor

$${Δ}_{n}^{AF , k}$$

for PAC k compared to PAC (k−1) for symbol n is calculated using:

$${Δ}_{n}^{AF , k} = {AF}_{n}^{k} - {AF}_{n}^{k - 1} \qquad ( Equation 15 )$$

where

$${AF}_{n}^{k - 1} and {AF}_{n}^{k}$$

are the assurance factors at the previous (k−1)th and current kth PAC, respectively.

The BER for PAC k and for symbol n is hereinafter referred to as

$$〈 {BER}_{n}^{k} 〉 . 〈 {BER}_{n}^{k} 〉$$

is estimated from

$$〈 {SER}_{n}^{k} 〉 as 〈 {SER}_{n}^{k} 〉$$

divided by the number of bits per symbol. In the case of an S-QAM system,

$$〈 {BER}_{n}^{k} 〉 = 〈 {SER}_{n}^{k} 〉 / {log}_{2} ( S ) .$$

When the adaptive feedback path control 141 communicates the estimated or calculated BER to the executive subsystem 133, at least one of the executive processing modules 2C-03-01 to 2C-03-N and planning module 2C-13 within executive subsystem 133 then perform an executive subsystem process flow.

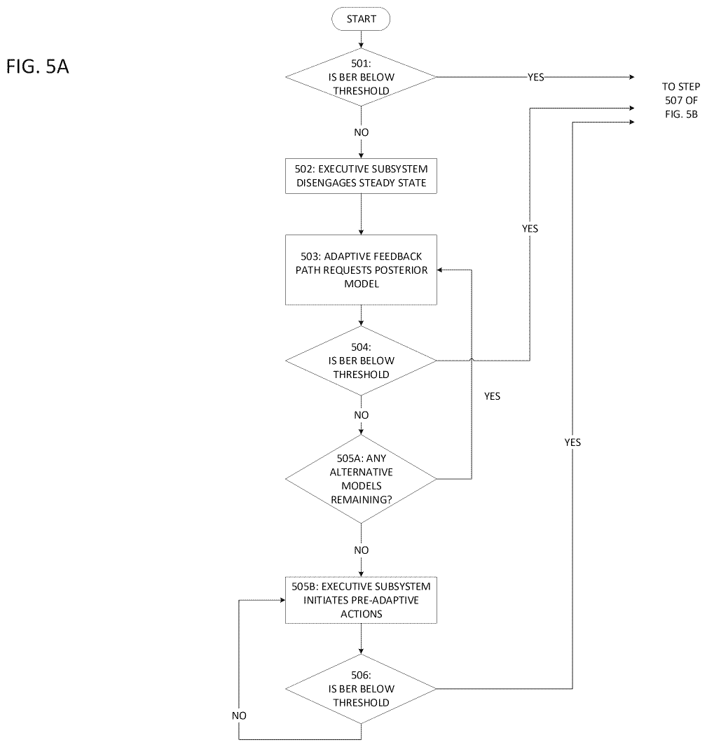

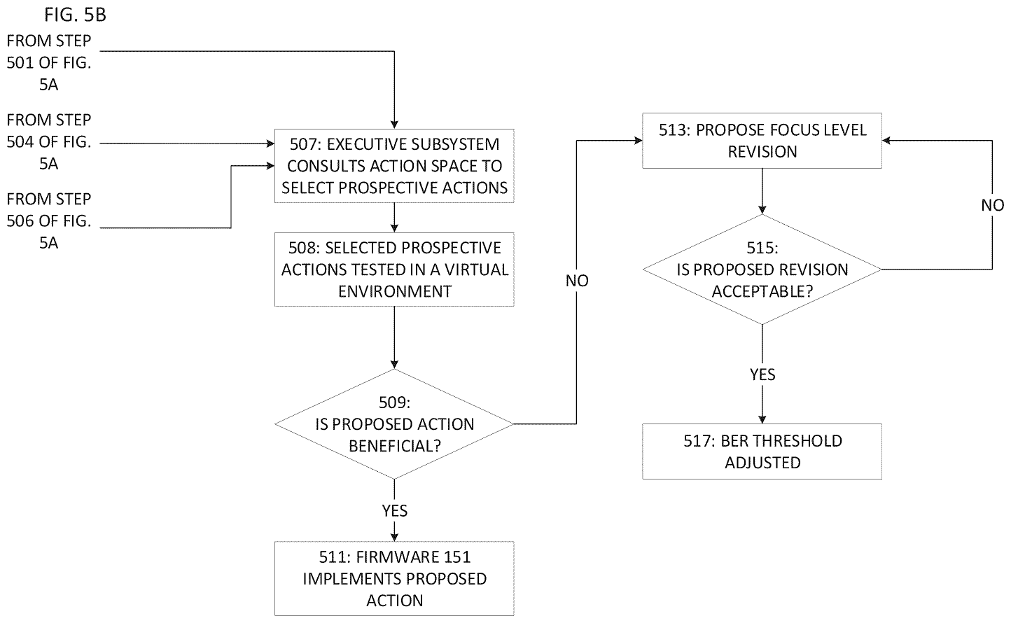

An illustrative embodiment of an executive subsystem process flow is shown in FIGS. 5A and 5B. In step 501 of FIG. 5A, the received estimated BER is compared against a predefined threshold set by executive policy 2C-09. As explained previously the threshold is set by either a client or a party having an authorized credential.

When the estimated BER is below the threshold, the planning module 2C-13 consults the action space to select a prospective action in step 507 of FIG. 5B.

When the estimated BER is above the threshold and the system is in steady state mode, in step 502 at least one of the planning module 2C-13 and the one or more executive processing modules 2C-03-01 to 2C-03-N in executive subsystem 133 disengages SDOCS 100 from steady state mode and transitions SDOCS 100 into training mode.

As part of this transition, at least one of the one or more processing modules 2C-03-01 to 2C-03-N and planning module 2C-13 in the executive subsystem 133 sends a signal to feedback subsystem 155. Then, feedback processing module 1D-07 within feedback subsystem 155 sends a signal to switch 105 in transmission 102 to begin selecting data input from transmission PRBS generator 101. Feedback processing module 1D-07 within feedback subsystem 155 is discussed in detail further below. In some embodiments, feedback processing module 1D-07 within feedback subsystem 155 sends a signal to transmission PRBS generator 101 to begin generating PRBS. As explained previously, reception PRBS generator 153 is synchronized to transmission PRBS generator 101. Then, reception PRBS generator 153 also generates synchronized PRBS for training.

At least one of the one or more processing modules 2C-03-01 to 2C-03-N and planning module 2C-13 in the executive subsystem 133 communicates to the adaptive feedback path control module 141 that: SDOCS 100 is being disengaged from steady state mode and is being transitioned into training mode.

In step 503, the adaptive feedback path control module 141 works together with one or more posterior processing modules 203-1 to 203-N to retrieve an alternative model from posterior library 209.

In step 504, adaptive feedback path 141 tests the retrieved model to determine whether the estimated BER using the retrieved alternative model is below the threshold.

When the adaptive feedback path 141 determines that the BER is below the threshold, then the planning module 2C-13 consults the action space to select a prospective action in step 507 of FIG. 5B.

When the adaptive feedback path 141 determines that the BER is above the threshold, in step 505A the adaptive feedback path 141 works together with one or more posterior processing modules 203-1 to 203-N to determine whether a suitable alternative model is found in posterior library 209.

When there is a suitable alternative model, then the process returns to step 503, where the adaptive feedback path 141 retrieves the suitable alternative posterior model from the posterior library 209, and tests to determine whether the BER is below the threshold in step 504. When the adaptive feedback path 141 determines that the BER is below the threshold, then the planning module 2C-13 in executive subsystem consults the action space to select a prospective action in step 507 of FIG. 5B.

When there are no suitable alternative models remaining in posterior library 209 in step 505A, the planning module 2C-13 of executive subsystem 133 initiates pre-adaptive actions in step 505B. As explained previously, pre-adaptive actions are predetermined actions designed to be effective before the SDOCS 100 has had a chance to learn or adapt from experience. These pre-adaptive actions comprise, for example, reducing the data rate incrementally to align the BER with acceptable levels.

While the BER is above the threshold (step 506), at least one of the one or more processing modules 2C-03-01 to 2C-03-N and planning module 2C-13 in the executive subsystem performs pre-adaptive actions. Once the BER is below the threshold, in step 507 the planning module 2C-13 in executive subsystem 133 consults the action space 2C-11 in executive storage 2C-07 to select prospective actions for adjusting parameters.

This differs from the approach used in Naghshvarianjahromi 1, where only adjustments to data rate are contemplated.

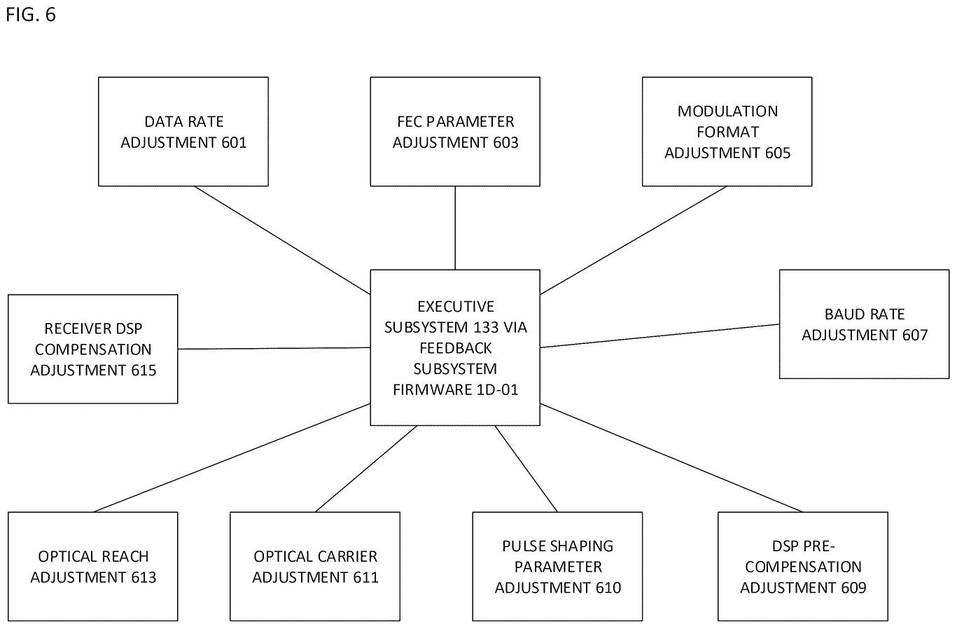

In some embodiments, the prospective actions available for selection comprise environmental actions, as previously discussed. Environmental actions are actions to adapt the SDOCS to varying external conditions. This involves at least one of the one or more processing modules 2C-03-01 to 2C-03-N and planning module 2C-13 in executive subsystem 133 dynamically adjusting operational parameters which are available to adjust via feedback subsystem firmware 1D-01. Examples are shown in FIG. 6, and include but are not limited to:
Data rate adjustment 601;
Forward Error Correction (FEC) parameter adjustment 603 such as turning SD decoding on and off in reception error correction decoding module 147;
Modulation format adjustment 605: in some embodiments, this comprises switching between different modulation formats such as BPSK, QPSK, or S-QAM depending on, for example, the current data rate demands and the quality of the optical carrier;
Baud rate adjustment 607;
One or more reception DSP pre-compensation setting adjustments 608 in reception DSP pre-compensation module 113, where in some embodiments, the adjustments comprise removing all reception DSP pre-compensation;
One or more transmission DSP pre-compensation setting adjustments 609 in transmission DSP pre-compensation module 113 to compensate for impairments such as non-linear distortion, thus maintaining the desired optical reach and ensuring the integrity of client data transmission across varying distances. In some embodiments, the adjustments comprise removing all transmission DSP pre-compensation;
Adjustment of parameters related to pulse shaping operations 610 carried out by pulse shaping module 111;
Optical carrier parameter adjustment 611, such as frequency of light waves emitted by laser 119;
Optical reach adjustment 613; and
One or more reception DSP pre-compensation setting adjustments 615 in reception DSP pre-compensation module 129.

By executing these environmental actions, the executive subsystem 133 continuously optimizes the optical network to adapt to changing conditions and deliver consistent, high-quality service.

In some embodiments, the prospective actions available for selection comprise internal commands. Internal commands are instructions sent by the executive module to the perceptor to modify modeling parameters. In some embodiments, internal commands comprise:
adjustments to the focus level,
adjustments to the precision factor vector, and
adjustments related to trade-offs between computational cost and cognitive decision-making accuracy.

In step 508, the selected prospective actions are then tested by at least one of one or more executive processing modules 2C-03-01 to 2C-03-N, and planning module 2C-13 within a virtual environment. The virtual environment simulates potential adjustments in a risk-free manner, allowing the system to evaluate the impact on an internal reward function prior to deployment in the “real-world”. By performing these simulations, an indication of the probability of success in the real world is obtained, and the probability of adverse consequences in the real-world is reduced.

The internal reward function is now explained. The internal reward function is designed to achieve one or more goals of the SDOCS 100. In some embodiments, for PAC k, and symbol n, the internal reward function denoted as

$${rw}_{n}^{k} ,$$

is based on the assurance factor, the incremental change in the assurance factor as explained below:

$${rw}_{n}^{k} = f ( {AF}_{n}^{k} , {Δ}_{n}^{AF , k} , {SDN}_{k}^{n} ) \qquad ( Equation 16 )$$

where:
   ƒ(⋅) is a function,

$$A {F}_{n}^{k}$$

is the assurance factor for PAC k and symbol n as explained previously;

$${Δ}_{n}^{AF , k}$$

is the change in the assurance factor for PAC k compared to PAC (k−1) for symbol n, as explained previously; and

$$S D {N}_{n}^{k}$$

is a set of parameters for symbol n and PAC k intended for optimization in the optical communication system. These include the parameters for adjustment shown in FIG. 6.

In other embodiments,

$$r {w}_{n}^{k}$$

is based on the estimated BER and the incremental change in BER:

$$r {w}_{n}^{k} = f ( 〈 B E {R}_{n}^{k} 〉 , {Δ}_{k}^{B , n} , SD {N}_{k}^{n} ) \qquad ( Equation 17 )$$

where:
ƒ(⋅) and

$$S D {N}_{n}^{k}$$

are as previously defined,

$$〈 B E {R}_{n}^{k} 〉$$

is the estimated BER for PAC k and the symbol n as explained previously; and

$${Δ}_{n}^{B , k}$$

is the change in the BER for PAC k compared to PAC (k−1) for symbol n, that is;

$${Δ}_{k}^{B , n} = 〈 B E {R}_{n}^{k - 1} 〉 - 〈 B E {R}_{n}^{k} 〉 \qquad ( Equation 18 )$$

As explained above, the internal reward function is designed to achieve one or more goals of the SDOCS 100. An example reward function is demonstrated below for embodiments where achieving the goals of optimizing for error and maximizing the data rate are important is as follows:

$$r {w}_{n}^{k} = \frac{〈 B E {R}_{n}^{k} 〉}{{( {R}_{k} - {R}_{r e f} )}^{4}} \qquad ( Equation 19 )$$

where:
   Rₖ is the data rate at the current time, incremented by a fixed data rate discretization step d, and
   R_{ref} is a reference data rate.
      The data rate discretization step d is, for example, 4 Gb/s.

Then, the objective is to minimize the reward function by:
either reducing

$$〈 B E {R}_{n}^{k} 〉 ,$$

or
ensuring that the expression (Rₖ−R_{ref})⁴ is increased by increasing Rₖ above R_{ref} as much as possible.

As is known to one of ordinary skill in the art, typically BER is inversely related to Rₖ. Then using the expression in Equation 19 ensures that BER is not reduced by reducing Rₖ excessively, or Rₖ is not increased excessively at the expense of BER.

Additionally, the planning module 2C-13 receives modeling configurations like the precision factor vector PF^{k,m} from the perceptor subsystem 143 through internal feedback channel 139, as described previously. The planning module 2C-13 then uses this information to determine the appropriate action to apply to the SDOCS.

At least one of planning module 2C-13, and one or more executive processing modules 2C-03-01 and 2C-03-N then perform the following calculations: the ratio ρ^{k+1,t} for the next PAC (k+1) due to the virtual environmental action,

$${c}_{k + 1}^{t}$$

where t is the current virtual action index, is calculated based on the standard deviation of the observed values for current PAC k and previous PAC (k−1), that is:

$${ρ}^{k + 1 , t} = {max}_{s = 1 , 2 , … , S} ( \frac{std ( {\hat{Y}}_{n}^{k , m} \vert {\hat{X}}_{n}^{k} = {X}_{s} )}{std ( {\hat{Y}}_{n}^{k - 1 , m} \vert {\hat{X}}_{n}^{k - 1} = {X}_{s} )} ) \qquad ( Equation 20 )$$

In some embodiments, predicted discretized data vector for PAC (k+1), current virtual action index t and the focus level m is denoted as

$${\hat{Y}}_{n}^{( k + 1 ) , t , m} \cdot {\hat{Y}}_{n}^{( k + 1 ) , t , m}$$

is calculated as:

$${\hat{Y}}_{n}^{( k + 1 ) , t , m} = h ( {\hat{Y}}_{n}^{k , m} , {ρ}^{k + 1 , t} , {c}_{k} , {c}_{k - 1} , t , m ) \qquad ( Equation 21 )$$

where h(⋅) is a function that takes into account:
   the current discretized data vector

$${\hat{Y}}_{n}^{k , m} ,$$

the action cₖ for PAC k,
the previous action cₖ₋₁ for PAC (k−1),
the ratio ρ^{k+1,t},
the current virtual action index t, and
the focus level m.

In other embodiments, another example function h(⋅) to predict posterior probability for virtual environmental action

$${c}_{k + 1}^{t}$$

is:

$${\hat{Y}}_{n}^{( k + 1 ) , t , m} = {\hat{Y}}_{n}^{k , m} \times {( {ρ}^{k + 1 , t} )}^{\frac{( m + 1 ) ( t \times d )}{2 ( {R}_{k} - {R}_{k - 1} )}} \\ Then , \qquad ( Equation 22 )$$

$${\hat{Y}}_{n}^{( k + 1 ) , t , m} = {\hat{Y}}_{n}^{k , m} \times {( {max}_{s = 1 , 2 , … , S} ( \frac{std ( {\hat{Y}}_{n}^{k , m} \vert {X}_{n}^{k} = {X}_{s} )}{std ( {\hat{Y}}_{n}^{k - 1 , m} \vert {X}_{n}^{k - 1} = {X}_{s} )} ) )}^{\frac{( m + 1 ) ( t \times d )}{2 ( {R}_{k} - {R}_{k - 1} )}} \qquad ( Equation 23 )$$

where S is the constellation size: for example, for QAM-16, S is 16,
d is the discretization step for the data rate, for example 4 Gb/s,
Rₖ and R₍ₖ₋₁₎ are the data rates at the kth and (k−1)th PAC, respectively.

The relationship in Equations 22 and 23 reflects that an increase in the data rate typically results in increased nonlinear distortions in fiber optic communications.

The standard deviation changes proportionally to alterations in the constellation order or the power level, similar to human imagination. Equation 23 also has a relatively low computational cost. Equation 23 allows the executive subsystem 133 to create virtual environments that emulate changes in the system's behavior due to different operational parameters.

These equations provide an indication of how SDOCS 100 will respond to potential future actions by simulating the outcome of these actions. The objective is to estimate how different configurations and conditions will affect the signal's characteristics, such as its standard deviation, in the context of optical communication systems.

In some embodiments, the predicted posterior probability due to the virtual action

$${c}_{k + 1}^{t}$$

is calculated, and sent by the posterior processing modules 203-1 to 203-N in the perceptor subsystem 133 to the executive subsystem 143 through internal feedback 137 as:

$${b}_{k} ( {\hat{X}}_{n}^{( k + 1 ) , t} , {\hat{Y}}_{n}^{( k + 1 ) , t , m} ) = P ( {\hat{X}}_{n}^{( k + 1 ) , t} \vert {\hat{Y}}_{n}^{( k + 1 ) , t , m} ) \qquad ( Equation 24 )$$

Here, the t∈{1, 2, . . . , T} and T is a total number of imaginative actions that the kth posterior sent by perceptor, is still valid for predicting the T^{th} virtual action outcome. The assurance factor

$$A {F}_{n}^{( k + 1 ) , t}$$

and its incremental change

$${Δ}_{k + 1 , t}^{AF , n}$$

are calculated as:

$$A {F}_{n}^{( k + 1 ) , t} = \frac{{\sum }_{b = n - L}^{n} P ( {\overline{X}}_{b}^{( k + 1 ) , t} \vert {\hat{Y}}_{b}^{( k + 1 ) , t , m} )}{L} , n - L \geq m , {Δ}_{k + 1 , t}^{AF , n} = {AF}_{n}^{k + 1 , t} - {AF}_{n}^{k + 1 , t - 1} \qquad ( Equation 25 )$$

The internal rewards for the desired virtual action

$${c}_{k + 1}^{t}$$

are calculated using:

$${rw}_{n}^{( k + 1 ) , t} = \{ \begin{matrix}{f}_{( k + 1 )} ( {AF}_{n}^{( k + 1 ) , t} , {Δ}_{k + 1 , t}^{AF , n} ) , & t ∈ \{ 1 , 2 , … , T \} \\ {rw}_{n}^{k} & t = 0\end{matrix} \qquad ( Equation 26 )$$

As mentioned before, T is the total number of virtual actions. Then, the action that either minimizes or maximizes the internal reward is selected.

In embodiments where minimizing the internal reward is the goal, the action

$${c}_{k + 1}^{{t}_{opt}}$$

that yields the minimum internal reward is selected as:

$${t}_{opt} = {arg min}_{t ∈ \{ 0 , 1 , 2 , … , T \}} ( {rw}_{n}^{( k + 1 ) , t} ) \qquad ( Equation 27 )$$

In embodiments where maximizing the internal reward is the goal, the action

$${c}_{k + 1}^{{t}_{opt}}$$

that yields the maximum internal reward is selected as:

$${t}_{opt} = {arg min}_{t ∈ \{ 0 , 1 , 2 , … , T \}} ( {rw}_{n}^{( k + 1 ) , t} ) \qquad ( Equation 28 )$$

Consequently, planning module 2C-13 selects the action to be applied to the environment, denoted as Cₖ₊₁, based on tₒₚₜ. In some embodiments, the executive policy 2C-09 adjusts the threshold to enhance accuracy or accept higher complexity as warranted.

In step 509, the impact on the internal reward is evaluated to determine whether a proposed action is beneficial or otherwise.

When a proposed action proves beneficial in step 509, then in step 511 at least one of executive processing modules 2C-03-01 to 2C-03-N; and planning module 2C-13 communicates signals comprising the proposed action to SDOCS feedback subsystem 155.

SDOCS feedback subsystem 155 comprises feedback processing module 1D-07, which comprises feedback subsystem firmware 1D-01 running on feedback subsystem processor 1D-03. None of the prior art systems demonstrated in Naghshvarianjahromi 1, Naghshvarianjahromi 2, Naghshvarianjahromi 3 and Naghshvarianjahromi 4 contemplated implementation of firmware running on a processor, such as feedback subsystem firmware 1D-01 running on feedback subsystem processor 1D-03. Feedback subsystem firmware 1D-01 offers a more sophisticated mechanism for integration of NI into SDOCS 100 compared to the previously demonstrated prior art systems.

Feedback subsystem firmware 1D-01 determines adjustments; and generates updates for different blocks in the SDOCS 100 such as input client data source 106, transmission 102 and reception 104 based on received signals from executive subsystem 133.

One of ordinary skill in the art would understand that feedback subsystem processor 1D-03 is a processor which is appropriate for this task. Feedback processing module 1D-07 is communicatively coupled to feedback subsystem database 1D-05.

Then, feedback processing module 1D-07 within SDOCS feedback subsystem 155, receives the signals comprising the proposed action from executive subsystem 133. Based on the received signals, the feedback subsystem firmware 1D-01 determines the adjustments necessary to implement the proposed action. In some embodiments, feedback subsystem firmware 1D-01 performs this determination based on data retrieved from feedback subsystem database 1D-05.

Feedback processing module 1D-07 implements the proposed action by transmitting signals to perform the determined adjustments to one or more components within transmission 102 or reception 104, or input client data source 106; via interconnections 1D-09. Interconnections 1D-09 is implemented using appropriate communications technologies. In some embodiments, fiber optic link 121 of FIG. 1A is used to implement interconnections 1D-09.

The signals to effect adjustments are described below with reference to FIGS. 1B, 1C, 1D and 6:
Signal to input client data source 106, to enable input client data 103 data rate adjustment 601;
Signals to transmission error correction coding 107 and reception error correction coding 147 to enable FEC parameter adjustment 603 such as switching soft decision (SD) decoding off, or switching hard decision (HD) decoding off;
Signal to bit symbol mapper 109 to effect modulation format adjustment 605;
Signal to bit symbol mapper 109 to enable baud rate adjustment 607;
Signal to transmission DSP pre-compensation module 113 to enable one or more transmission DSP pre-compensation setting adjustments 609;
Signal to pulse shaping module 111 to enable adjustment of parameters related to pulse shaping operations 610;
Signal to laser 119 to enable adjustment of optical carrier parameters;
Optical reach adjustment 613; and
Signal to reception DSP pre-compensation module 129 to enable one or more reception DSP pre-compensation setting adjustments 615.

Interconnections 1D-09 are implemented using appropriate communication technologies known to those of ordinary skill in the art.

Along with adjustments, as described previously, feedback subsystem firmware 1D-01 generates commands to be sent to for example, transmission PRBS generator 101 and switch 105 when SDOCS 100 transitions from steady state mode into training mode and vice versa. Then, feedback processing module 1D-07 sends signals comprising these commands to these various components as is appropriate.

When no action enhances system performance in step 509, then in step 513 a revision to the focus level m is proposed.

In step 515 the planning module 2C-13 checks whether this proposed revision adheres to the complexity threshold established by the policy using the equations above. In some embodiments, this comprises comparing the complexity threshold to the available memory.

When the revised focus level is acceptable, then in step 517, planning module 2C-13 adjusts the BER threshold accordingly and communicates these changes to the perceptor subsystem 143 via internal commands transmitted over the internal feedforward channel 139. This feedback initiates another round of assessment and adaptation, refining the decision-making process at the new focus level.

Performing the above process flow enables the implementation of a continuous feedback loop, wherein: Based on the functioning and performance metrics of the fiber optic link 121, parameters related to transmission 102, input client data 103 and reception 104 are adjusted so as to improve the overall performance of SDOCS 100.

The above also describes a perception action cycle for SDOCS which are NGNLE.

Returning to FIG. 1E: In step 1E-25, the output signal comprising symbols from NI processing subsystem 131 is transmitted to reception symbol-to-bit demapper 146, where the received symbols are mapped to bits. As explained previously, in some embodiments step 1E-25 is performed in parallel with step 1E-23.

One of ordinary skill in the art would understand that this de-mapping is performed based on the modulation format used by transmission bit symbol mapper 109. Techniques to ensure that reception symbol-to-bit demapper 146 is synchronized to transmission bit symbol mapper 109 are known to those of ordinary skill in the art and are not discussed further here.

Reception symbol-to-bit demapper 146 produces an output signal comprising the de-mapped bits. This output signal is received by reception error correction decoding module 147.

The reception error correction decoding module 147 implements error correction decoding, including decoding of data encoded using forward error correction codes.

In some embodiments, reception error correction decoding module 147 performs either HD decoding or SD decoding as needed. As is also known to those of ordinary skill in the art, HD decoding has lower correction performance and coding gain relative to SD decoding techniques. For example, as explained in “Soft Decision Forward Error Correction for Coherent Super-Channels”, Infinera, White paper, https://www.infinera.com/wp-content/uploads/Soft-Decision-Forward-Error-Correction-for-Coherent-Super-Channels-0189-WP-RevA-0519.pdf retrieved 26 May 2024; SD decoding provides coding gain of up to 11 dB or more with an overhead of 15% to 35% depending on the implementation.

Although the SD decoding provides significant performance advantage due to larger coding gain, there are some disadvantages. SD decoding requires more transmission overhead than HD decoding which can reduce effective data rate. For example, when SD decoding with 35% overhead is used, 35% of the channel time is used to send the redundant data and only 65% of the channel time is utilized to send the actual data, which significantly lowers the effective data rate.

Furthermore, SD decoding involves more complex calculations relative to HD decoding. These complex calculations lead to enhanced power consumption and increased latency within reception error correction decoding module 147. These disadvantages make SD decoding unattractive for certain applications, such as in data center networks.

Then, in some embodiments, as previously discussed, based on signals sent by feedback subsystem firmware 1D-01, SD decoding is turned on and off within reception error correction decoding module 147. This has the advantage of enabling better control of power consumption and latency.

The combination of HD decoding and the NI systems and methods explained above can provide the same net coding gain as a system that uses SD decoding. Then, in some embodiments, reception error correction decoding module 147 performs only HD decoding, thereby removing the overhead due to SD decoding and increasing the effective data rate.

In yet other embodiments, based on signals sent by feedback subsystem firmware 1D-01 to reception error correction decoding module 147 and transmission error control coding module 107, forward error correction is turned off entirely. That is, no error correcting operations are performed in transmission error control coding module 107; and both HD and SD decoding are turned off. This further increases the effective data rate by reducing transmission overhead. It can also reduce latency overheads.

One of ordinary skill in the art would also understand that transmission error control coding module 107 and reception error correction decoding module 147 are synchronized so that reception error correction decoding module 147 is able to decode the bits received in the output signal from reception symbol-to-bit de-mapper 146, and generate output client data 148.

The systems and methods described above revolutionize optical communication systems by embedding NI into SDOCS, substantially elevating performance and operational efficiency. The systems and methods described above address and overcome the nonlinear impairments that have long constrained the efficiency and performance of optical fiber networks.

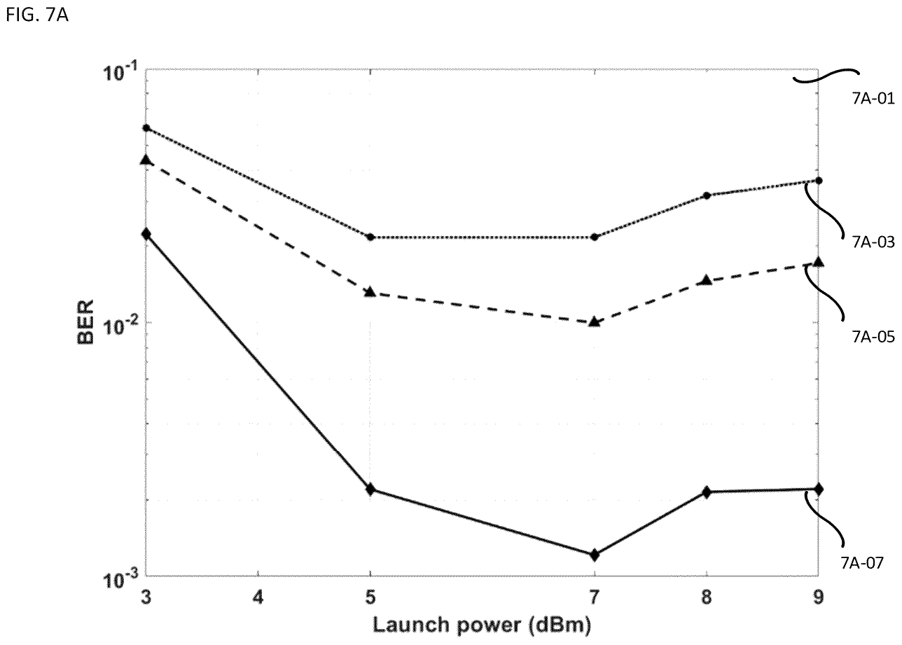

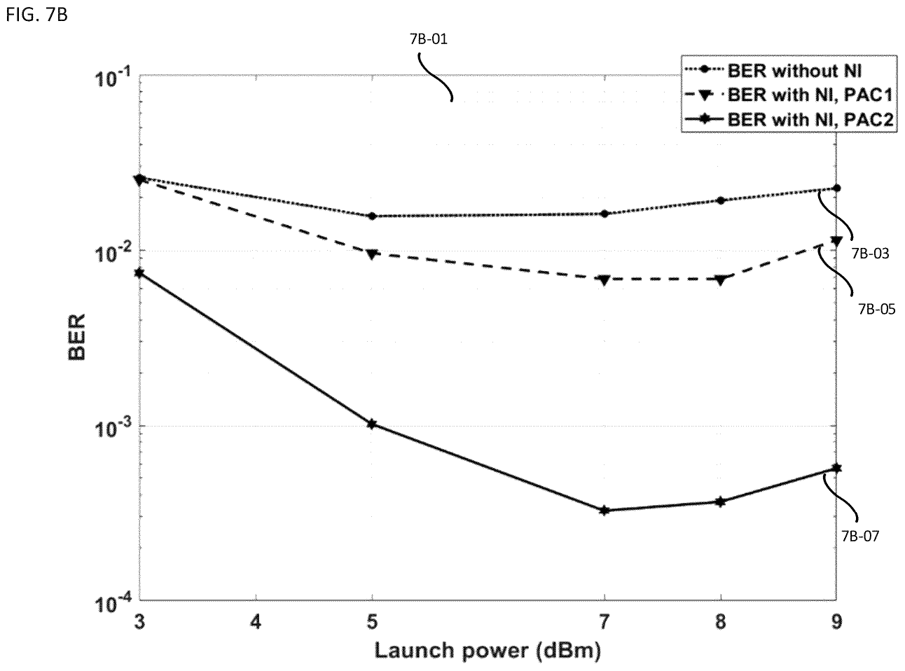

Experimental results substantiate the effectiveness of the systems and methods described above. For example, in an embodiment of an Optical Time Division Multiplexing (OTDM) setup, hereinafter referred to as “OTDM Setup 1” which has imperfect clock recovery, in graph 7A-01 shown in FIG. 7A:
curve 7A-03 shows BER vs launch power for a system without NI,
curve 7A-05 shows BER vs launch power for a system with one perception action cycle (PAC1), and
curve 7A-07 shows BER vs launch power for a system with PAC 2.

At every launch power level BER is improved with the addition of NI, and BER improves with more perception action cycles (PACs). For example, at a launch power of 7 dBm, mean BER is reduced from 2.2×10⁻² without NI in curve 7A-03 to 1.0×10⁻² in a system with NI within PAC 1 in curve 7A-05, and further to 1.2×10⁻³ in PAC 2 in curve 7A-07.

The measured BER correlates directly with the Q-factor, an established parameter of signal quality. Q factor can be calculated by

$$Q = 20 {log}_{10} [ \sqrt{2} {erfc}^{- 1} ( 2. BER ) ] \qquad ( Equation 29 )$$

Then, applying Equation 29 to the BERs obtained in curves 7A-03, 7A-05 and 7A-07: the integration of NI yields an approximate 1.3 dB increase in Q-factor in PAC1 and a 3.0 dB enhancement in PAC2 in OTDM Setup 1.

For an OTDM setup having near-perfect or at least substantially improved clock recovery compared to OTDM Setup 1 and hereinafter referred to as “OTDM Setup 2”, in graph 7B-01 shown in FIG. 7B:
curve 7B-03 shows BER vs launch power for a system without NI,
curve 7B-05 shows BER vs launch power for a system with one perception action cycle (PAC1), and
curve 7B-07 shows BER vs launch power for a system with PAC 2.

Then, as shown in graph 7B-01, at every launch power level BER is improved with the addition of NI, and BER improves with more perception action cycles (PACs). For example, at a launch power of 7 dBm, mean BER is reduced from 1.6×10⁻² without NI in curve 7B-03 to 6.8×10⁻³ in a system with NI within PAC 1 in curve 7B-05, and further to 3.2×10⁻⁴ in PAC 2 in curve 7B-07.

In OTDM Setup 2, as referenced in curves 7B-03, 7B-05 and 7B-07 in FIG. 7B: using Equation 29, the Q-factor's improvement is slightly more pronounced, showing 1.2 dB improvement in PAC1 and 3.5 dB improvement in PAC2. Moreover, the system exhibits a shift in the optimum launch power from 5 dBm without NI to 7 dBm with NI, demonstrating a heightened tolerance to nonlinear distortion thanks to the NI's involvement.

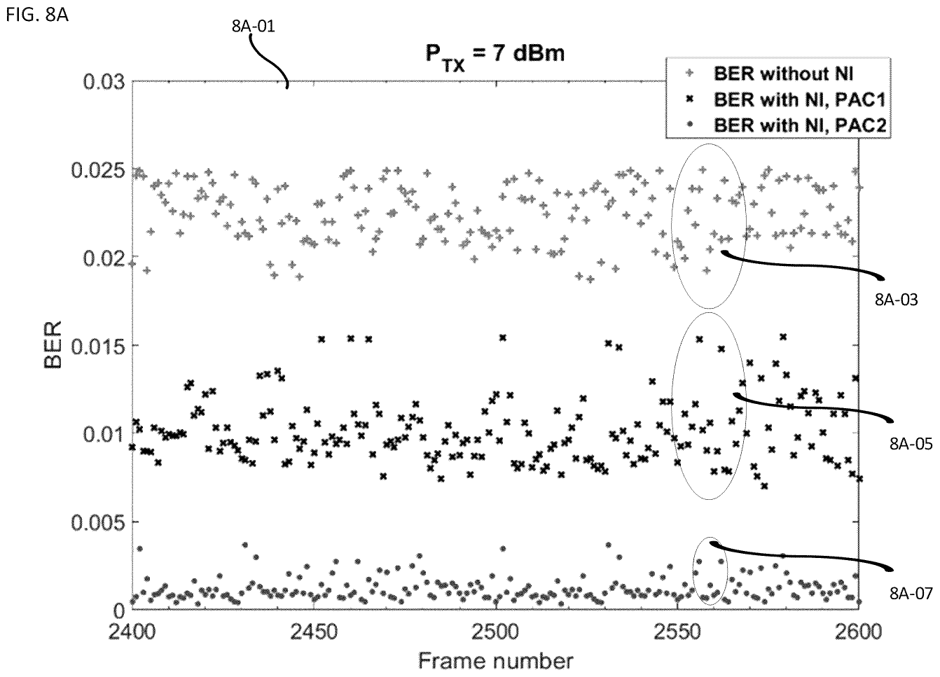

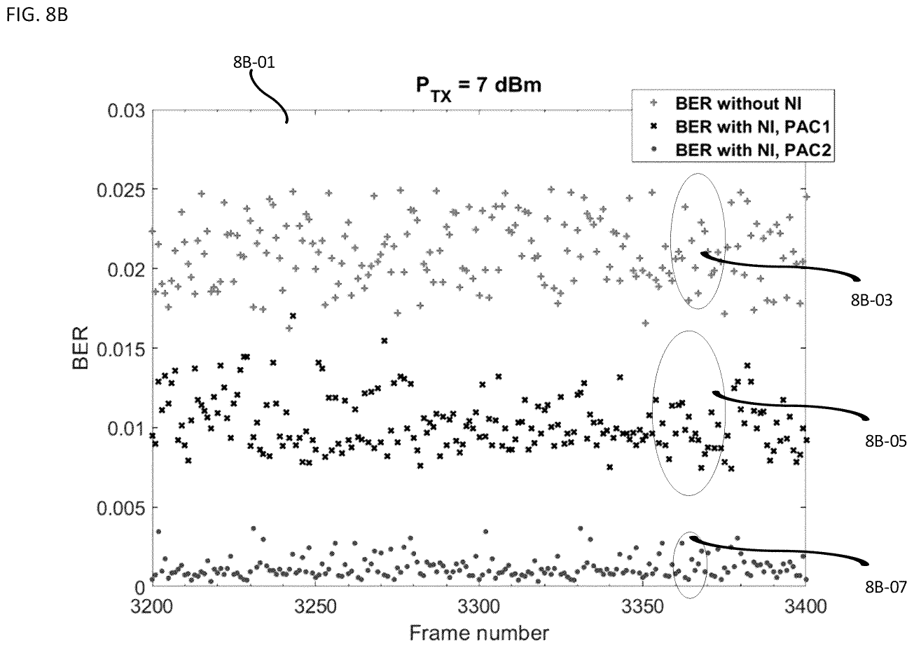

BER variation is also reduced due to the introduction of NI. For example, in FIGS. 8A and 8B with a launch power of 7 dBm:
the BER on a frame-by-frame basis in an OTDM setup before the integration of NI in a group of frames 2400-2600 with less than perfect clock recovery (group 8A-03), and in a group of frames 3200 to 3400 with near-perfect or at least substantially improved clock recovery (group 8B-03) lie between 1.6×10⁻² to 2.5×10⁻²;
the BER on a frame-by-frame basis after the integration of NI in group of frames 2400-2600 with less than perfect clock recovery (group 8A-05), and in group of frames 3200-3400 with substantially improved clock recovery (group 8B-05) lie between 6.8×10⁻³ to 1.7×10⁻² within PAC 1; and
the BER on a frame-by-frame basis after the integration of NI in group of frames 2400-2600 with less than perfect clock recovery (group 8A-07), and in group of frames 3200-3400 with substantially improved clock recovery (group 8B-07) lie between 3.2×10⁻⁴ to 3.7×10⁻³ within PAC 2.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an ASIC, a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system for natural intelligence (NI) processing in a reception subsystem for a software defined optical communications system (SDOCS) comprising:
a perceptor subsystem communicatively coupled to an executive subsystem via interconnections, wherein:
the perceptor subsystem comprises a posterior storage and one or more posterior processing modules coupled to each other by perceptor subsystem interconnections, and
the executive subsystem comprises an executive storage, one or more executive processing modules and a planning module coupled to each other by executive subsystem interconnections;
a feedback subsystem communicatively coupled to the executive subsystem, a transmission subsystem, a reception subsystem and an input client data source, wherein:
the feedback subsystem comprises a feedback processing module communicatively coupled to a feedback subsystem database, further wherein:
the feedback processing module comprises a feedback subsystem firmware running on a feedback subsystem processor;
an adaptive feedback path control module communicatively coupled to the executive subsystem and the perceptor subsystem, wherein:
the perceptor subsystem receives perceptions comprising a plurality of transmitted symbols,
based on the received plurality of transmitted symbols,
determining whether a suitable posterior model is available in the posterior storage,
when a suitable posterior model is available, the one or more posterior processing modules retrieves a posterior model from the posterior storage, and
the one or more posterior processing modules communicates the retrieved posterior model to the adaptive feedback path control module,
the adaptive feedback path control module estimates a bit error rate (BER) using the retrieved posterior model,
the adaptive feedback path control module communicates the estimated BER to the executive subsystem,
when the estimated BER is below a threshold, the planning module selects a prospective action from the executive storage,
at least one of the planning module and the one or more executive processing modules test the selected prospective action in a virtual environment,
at least one of the planning module and the one or more executive processing modules determines whether the selected prospective action is beneficial,
when the selected prospective action is beneficial, either the planning module or the one or more executive processing modules communicates signals comprising the selected prospective action to the feedback subsystem, and
the feedback processing module:
receives the signals comprising the selected prospective action,
determines, based on the received signals, an adjustment to implement the selected prospective action, and
transmits signals to perform the determined adjustment to one or more components within the transmission or the reception, or the input client data source.

2. The system of claim 1, wherein the adjustment comprises two or more of:
a data rate adjustment;
a forward error correction parameter adjustment;
a modulation format adjustment;
a baud rate adjustment;
a transmission DSP pre-compensation setting adjustment;
an adjustment of at least one parameter related to a pulse shaping operation;
an optical carrier parameter adjustment;
an optical reach adjustment; and
a reception DSP pre-compensation setting adjustment.

3. The system of claim 1, wherein
the posterior storage comprises a posterior library; and
the one or more posterior processing modules retrieve the posterior model from the posterior library.

4. The system of claim 1, wherein:
the executive storage comprises an action library; and
the planning module retrieves the selected prospective action from the action library.

5. The system of claim 1, wherein:
when the estimated BER is above a threshold, the adaptive feedback path control module requests a posterior model from the perceptor subsystem.

6. The system of claim 1, wherein
when the suitable posterior model is not available, the one or more posterior processing modules extracts a new posterior model.

7. The system of claim 6, wherein the extracting of the posterior model comprises training using training data generated by a transmission pseudo-random bit sequence (PRBS) generator.

8. The system of claim 1, wherein the plurality of transmitted symbols is based on
either input client data from an input client data source, or
training data transmitted by a transmission PRBS generator.

9. The system of claim 1, wherein the determining of whether the selected prospective action is beneficial comprises either minimizing or maximizing an internal reward.

10. The system of claim 8, wherein the plurality of transmitted symbols is based on:
the input client data when the SDOCS is in a steady state mode, and
the training data when the SDOCS is in a training mode.

11. A method for NI processing in a reception subsystem for an SDOCS comprising:
receiving, by a perceptor subsystem, perceptions comprising a plurality of transmitted symbols;
determining, based on the received plurality of transmitted symbols, whether a suitable posterior model is available in a posterior storage within the posterior subsystem;
when a suitable posterior model is available, retrieving, by one or more posterior processing modules within the posterior subsystem, a posterior model from the posterior storage;
communicating, by the one or more posterior processing modules, the retrieved posterior model to an adaptive feedback path control;
estimating, by the adaptive feedback path control module, a bit error rate (BER) using the retrieved posterior model;
communicating the estimated BER to an executive subsystem;
when the estimated BER is below a threshold, selecting, by a planning module within the executive subsystem, a prospective action from an executive storage;
testing, by at least one of the planning module and one or more executive processing modules within the executive subsystem, the selected prospective action in a virtual environment;
based on the testing, determining, by at least one of the planning module and one or more executive processing modules, whether the selected prospective action is beneficial;
when the selected prospective action is beneficial, communicating, by either the planning module or the one or more executive processing modules, signals comprising the selected prospective action to a feedback subsystem;
receiving, by a feedback processing module within the feedback subsystem, the signals comprising the selected prospective action;
based on the received signals, determining, by the feedback processing module, an adjustment to implement the selected prospective action; and
transmitting, by the feedback processing module, signals to perform the determined adjustment to one or more components within
a transmission in the SDOCS,
a reception within the SDOCS, or
an input client data source to the SDOCS.

12. The method of claim 11, wherein the adjustment comprises two or more of:
a data rate adjustment;
a forward error correction parameter adjustment;
a modulation format adjustment;
a baud rate adjustment;
a transmission DSP pre-compensation setting adjustment;
an adjustment of at least one parameter related to a pulse shaping operation;
an optical carrier parameter adjustment;
an optical reach adjustment; and
a reception DSP pre-compensation setting adjustment.

13. The method of claim 11, wherein:
the receiving of the perceptions comprising a plurality of transmitted symbols occurs either prior to or parallel to a symbol-to-bit demapping.

14. The method of claim 11, wherein:
the executive storage comprises an action library; and
the method further comprising:
testing, by the planning module, the selected prospective action from the action library.

15. The method of claim 11, further comprising:
requesting, by the adaptive feedback path control module, a posterior model from the perceptor subsystem when the estimated BER is above a threshold.

16. The method of claim 11, further comprising:
extracting, by the one or more posterior processing modules, a new posterior model when the suitable posterior model is not available.

17. The method of claim 16, wherein
the extracting of the posterior model comprises training using training data generated by a transmission PRBS generator; and
the extracting is based on a non-Bayesian approach.

18. The method of claim 11, wherein:
the plurality of transmitted symbols is based on an output of a switch;
the output of the switch is:
input client data from an input client data source when the SDOCS is in a steady state mode, or
training data transmitted by a transmission PRBS generator when the SDOCS is in a training mode.

19. The method of claim 11, wherein the determining of whether the selected prospective action is beneficial is based on either minimizing or maximizing an internal reward.

20. The method of claim 12, wherein the forward error correction parameter adjustment comprises
either selecting only hard decision decoding; or
switching off hard decision and soft decision decoding.
